(19) United States
(12) Patent Application Publication
(10) Pub. No.: US 2024/0265471 A1
(43) Pub. Date: Aug. 8, 2024

(54) DYNAMICALLY GENERATED TEST QUESTIONS FOR AUTOMATIC QUALITY CONTROL OF SUBMITTED ANNOTATIONS

(71) Applicant: Appen Limited, Chatswood (AU)

(72) Inventors: MingKuan Liu, San Jose, CA (US); Kuo-Chin Lien, Palo Alto, CA (US)

(21) Appl. No.: 18/163,735

(22) Filed: Feb. 2, 2023

(51) Int. Cl. G06Q 50/00; G06Q 10/0639

(52) U.S. Cl. CPC G06Q 50/01; G06Q 10/06398

(57) ABSTRACT

Dynamically generated test questions for automatic quality control of submitted annotations is disclosed, including: distributing a first subset of queries from input data associated with an annotation job to a plurality of annotator devices via an annotation platform; receiving a set of annotation results corresponding to the first subset of queries from the annotator devices; dynamically generating a set of test questions and corresponding test answers based on the first subset of queries and the set of annotations results; distributing a second subset of queries from the input data and the set of test questions to the annotator devices via the annotation platform; and performing an action corresponding to a contributor with respect to the annotation job based on a submitted answer, received from a corresponding annotator device, corresponding to at least one test question of the set of test questions.

### BACKGROUND OF THE INVENTION

Completing annotations on data using a managed crowd of workers results in good quality annotations but the size of the pool of workers may be limited. As a result of the limited number of workers in a managed crowd, the annotation throughput may be limited. Additionally, worker recruiting and onboarding time is laborious and time consuming. Furthermore, annotation by the limited number of workers of data may be inefficient and also expensive.

Completing annotations using an open crowd of workers has the advantages of a large worker pool, high job throughputs, and quick turn over time. However, the quality of the annotation work by an open crowd of workers is usually low due to the difficulty in controlling the quality of the worker submitted annotations. For example, a worker could submit fraudulent annotations by providing random annotations. In another example, a worker could perform lower quality work by providing careless annotations. Conventionally, test questions are provided to workers to confirm their competency in performing the desired annotation work. However, it is laborious to manually generate test questions in advance of distributing annotation tasks to workers. Furthermore, the number of test questions that could be generated in advance of distributing annotation tasks to workers could be limited and insufficient to provide the workers without having to resort to recycling the same test questions over and over. The failure to properly configure test questions could lead to workers submitting annotations of lower quality, which would lead to an overall decrease in the quality of work on annotation projects.

### BRIEF DESCRIPTION OF THE DRAWINGS

Various embodiments of the invention are disclosed in the following detailed description and the accompanying drawings.

FIG. 1 is a diagram showing a system for dynamically generating test questions and for automatic quality control of submitted annotations.

FIG. 2 is a diagram showing an example of an annotation platform server.

FIG. 3 is a schematic diagram showing an example of dynamic test generation and quality control of submitted annotations as performed by an annotation platform server in accordance with embodiments described herein.

FIG. 4 is a flow diagram showing an embodiment of a process for dynamic test question generation for automatic quality control of submitted annotations.

FIG. 5 is a flow diagram showing an example of a process for dynamic test question generation for automatic quality control of submitted annotations.

FIG. 6 is a flow diagram showing an example of a process for dynamically generating the self-consistency type of test question.

FIG. 7 is a diagram showing an example of the generation and the assignment of a self-consistency type of test question.

FIG. 8 is a flow diagram showing an example of a process for dynamically generating the cross-consistency type of test question.

FIG. 9 is a diagram showing an example of the generation and the assignment of a cross-consistency type of test question.

FIG. 10 is a flow diagram showing an example of a process for dynamically generating the manipulated consistency type of test question.

FIG. 11 is a diagram showing an example of the generation and the assignment of a manipulated consistency type of test question.

FIG. 12 is a flow diagram showing an example of a process for dynamically generating the manipulated combination consistency type of test question.

FIG. 13 is a diagram showing an example of the generation and the assignment of a manipulated consistency type of test question.

FIG. 14 is a flow diagram showing an example of a process for aggregating contributor user submitted annotation results for an annotation job.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of dynamically generating test questions for automatic quality control of submitted annotations are described herein. An annotation job comprising raw input data to be annotated and a selected annotation type are received. For example, an annotation job is created by a data scientist or a data engineer at an enterprise that is looking to efficiently annotate a body of data (e.g., text, images, audio, point cloud, or other media) so that the annotated data can be used to build a new or update an existing machine learning model for automatically annotating subsequent data input. In various embodiments, a selected “annotation type” comprises the type of annotation that should be performed on the raw input data. A first subset of queries of the input data associated with the annotation jobs are distributed to a plurality of annotator devices via an annotation platform. A set of annotation results corresponding to the first subset of queries is received from the plurality of annotator devices. In various embodiments, an “annotation result” is an annotation of the selected annotation type associated with the annotation type that is submitted by a query by a contributor via a corresponding annotator device. A set of test questions and corresponding test answers are dynamically generated at least in part on the first subset of queries and the set of annotation results. In some embodiments, a test question is generated from a query that was previously distributed to a contributor and the corresponding test answer to that test question is generated from the annotation result to that query that was submitted by that contributor. A second subset of queries from the input data and the set of test questions are distributed to the plurality of annotator devices via the annotation platform. An action is performed corresponding to a contributor with respect to the annotation job based at least in part on a submitted answer, received from a corresponding annotator device, to at least one test question of the set of test questions.

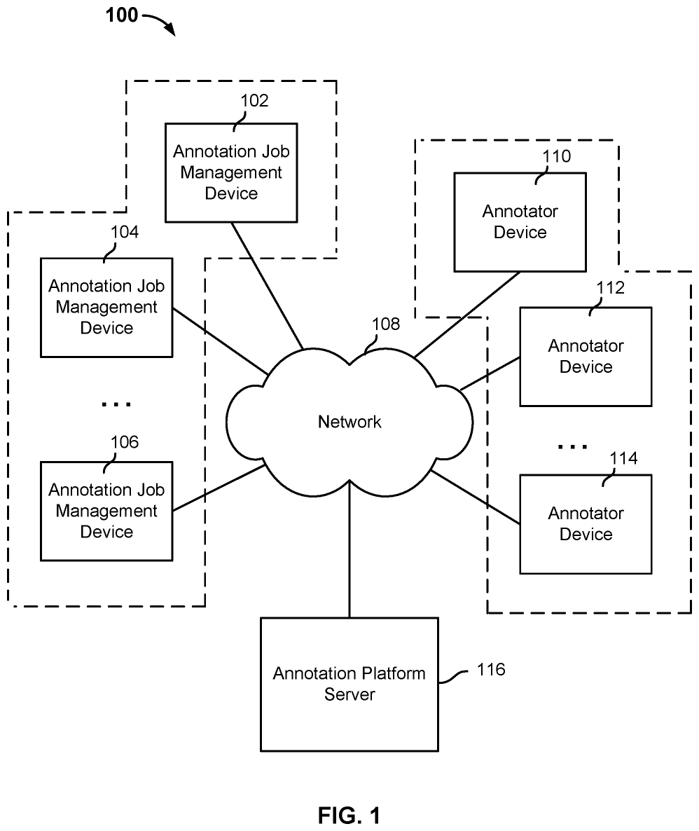

FIG. 1 is a diagram showing a system for dynamically generating test questions and for automatic quality control of submitted annotations. In the example of FIG. 1, system 100 includes a set of annotation job management devices (including annotation job management devices 102, 104, and 106), a set of annotator devices (including annotator devices 110, 112, and 114), network 108, and annotation platform server 116. Each of annotation job management devices 102, 104, and 106 communicates with annotation platform server 116 over network 108. Each of annotator devices 110, 112, and 114 communicates with annotation platform server 116 over network 108. Each of annotator devices 110, 112, and 114 can be a desktop computer, a laptop computer, a mobile device, a tablet device, and/or any computing device. Network 108 includes data and/or telecommunications networks. System 100 merely shows example numbers of annotation job management devices and annotator devices. In actual practice, more or fewer annotation job management devices and annotator devices may be communicating with annotation platform server 116.

An annotation job management device (such as any of annotation job management devices 102, 104, and 106) may be a desktop computer, a tablet device, a smart phone, or any networked device. An annotation job management device may be operated by a user, for example, that is responsible for obtaining annotated training data (e.g., to aid in the creation of a new machine learning model or the updating of an existing machine learning model that is configured to automatically annotate input data). For example, an annotation job management device may be operated by a user with a project manager, a data scientist, or a data engineer role at an enterprise. To start a new annotation job, the annotation job management device is configured to send a request to create a new annotation job to annotation platform server 116. To create the new annotation job, the annotation job management device is configured to upload raw input data and a selected annotation type associated with the annotation job to annotation platform server 116. In some embodiments, the raw input data may be text, images, audio, video, point cloud, or other media. In some embodiments, the selected annotation type comprises the desired type of annotation that is to be performed on the raw input data. In a first example, where the raw input data comprises text data, the selected annotation type may be to annotate the parts of speech or other categories associated with the words/phrases within each sentence of the text. In a second example, where the raw input data comprises image data, the selected annotation type may be to annotate the category of one or more subjects (e.g., a type of person, a type of animal, or a type of object) that appears within the image. In a third example, where the raw input data comprises image data, the selected annotation type may be to annotate the bounding box/location/outline around a subject within each image. In a fourth example, where the raw input data comprises audio data, the selected annotation type may be to transcribe each word/phrase spoken within the audio. In a fifth example, where the raw input data comprises point cloud data, the selected annotation type may be to label the category of the subject that appears in point cloud form. In some embodiments, the raw input data may already be segmented into discrete units of data. For example, where the raw input data comprises text data, a unit of data comprises one or two sentences. In another example, where the raw input data comprises image data, a unit of data comprises a single image. In yet another example, where the raw input data comprises audio data, a unit of data comprises an audio clip. In some embodiments, in the event that the raw input data is not already segmented into discrete units of data, annotation platform server 116 is configured to segment the raw input data into discrete units of data. In a specific example, if the annotator job creator user of the annotation job management device is a project manager/data scientist/engineer at an enterprise, the raw input data may be collected from the enterprise's customers. For example, search queries, emails, transcribed voice messages, and/or reviews that are submitted by an enterprise's customers may form the raw input data of an annotation job. In some embodiments, the annotation job management device is configured to send criteria associated with contributor users (who are sometimes referred to simply as “contributors”) to whom the raw input data is to be distributed for the contributor users to annotate. In various embodiments, each unit of raw input data that is sent to a contributor user to be annotated is referred to as a “query.” For example, the criteria of contributor users may include a pay rate, a desired level of experience, a desired language skill, and/or a desired geographic area of residency.

Conventionally, test questions are manually created and then submitted with a new annotation job from an annotation job management device to annotation platform server 116. However, according to various embodiments described herein, test questions can be dynamically (programmatically) generated by annotation platform server 116 as the annotation job is being worked on by selected contributor users based at least in part on annotation results that have been submitted by contributor users to queries associated with the annotation job. As such, in accordance with embodiments described herein, a growing number of new test questions can be generated in tandem as selected contributor users work on an annotation job. Put another way, a large volume of test questions does not need to be manually produced in advance of an annotation job being distributed to a selected group of contributor users and there is also no need to recycle test questions. As will be described in further detail below, the test questions associated with an annotation job will be used to evaluate the quality of the contributor users' submitted annotation results and programmatically identify certain contributor users whose annotation trust levels fall below a predetermined trust level threshold such that, in some embodiments, at least some of their submitted annotation results will be excluded from the aggregate annotation report to be generated for the annotation job.

In response to receiving data associated with a new annotation job from an annotation job management device (such as any of annotation job management devices 102, 104, and 106), annotation platform server 116 is configured to store information with the annotation job.

Annotation platform server 116 is configured to identify a candidate set of contributor users to work on an annotation job using the criteria of contributor users submitted with the annotation job. In various embodiments, annotation platform server 116 is configured to compare the criteria of contributor users submitted with the annotation job against the stored profiles of contributor users to identify the candidate set of contributor users that match the criteria. In some embodiments, optionally, to confirm that each contributor user of the candidate set of contributor users meets the desired skill level associated with the annotation job, annotation platform server 116 is configured to provide a portion of a predetermined set of test questions (e.g., which could have been manually generated or dynamically generated based on the queries and submitted annotation results associated with a previous annotation job) in a “Quiz Mode” to the corresponding annotator device of each candidate contributor user. Each test question is presented at a user interface that is shown at the annotator device of each candidate contributor user and the candidate contributor user is to submit the requested type of annotations (e.g., audio transcription, text labeling, image labeling, drawing the bounding box of a subject within an image, point cloud labeling) via the user interface to annotation platform server 116. In some embodiments, the user interface that is presented at the annotator device is configured with tools that enable the candidate contributor user to input annotations of the selected annotation type on each test question. Annotation platform server 116 is then configured to compare the submitted annotation results of each test question with the known test answer (e.g., a manually provided test answer or the submitted annotation result from a historical query) of that test question to determine whether the candidate contributor user had correctly answered the test question (e.g., the submitted annotation results match the known test answer over a predetermined threshold match). If a candidate contributor user had correctly answered at least a predetermined percentage/portion of the provided test questions of the “Quiz Mode” correctly, then annotation platform server 116 is configured to determine that the candidate contributor user is now a “trusted” contributor user that can proceed to the “Work Mode” portion of the annotation job. As will be described in further detail below, during the “Work Mode” portion of the annotation job, annotation platform server 116 is to provide job batches comprising combinations of queries (units of raw input data) and dynamically generated test questions associated with the annotation job to the annotator device of each trusted contributor user so that the trusted contributor can begin submitting annotations on the raw input data and test questions. Otherwise, if a candidate contributor user had correctly answered less than a predetermined percentage/portion of the provided test questions of the “Quiz Mode” correctly, then annotation platform server 116 is configured to deny the candidate contributor user job batches associated with the annotation job because the contributor user does not meet the desired skill level needed for the annotation job.

Annotation platform server 116 is configured to distribute job batches associated with an annotation job to the annotator devices of trusted contributor users with respect to that annotation job. In some embodiments, the raw input data of an annotation job is divided into portions (which are sometimes referred to as “queries”) and each is included in a job batch. Before any annotation results have been submitted by a contributor to queries distributed in any job batch associated with the annotation job, each distributed job batch will include only queries of raw input data. Each query that is received at an annotator device (e.g., such as annotator devices 110, 112, and 114) is presented at a user interface that is shown at the annotator device of each trusted contributor user and the trusted contributor user is to submit the requested type of annotation results (e.g., audio transcription, text labeling, image labeling, drawing the bounding box around a subject within an image, point cloud labeling) via the user interface to annotation platform server 116. After annotation platform server 116 receives submitted annotation results from annotator devices to distributed queries associated with the annotation job, annotation platform server 116 is configured to dynamically generate test questions based on the pairs of distributed queries and received submitted annotation results. Annotation platform server 116 is configured to dynamically generate test questions based on queries associated with the annotation job for which one or more contributors have already submitted annotation results. Annotation platform server 116 is further configured to generate known test answers corresponding to those test questions based on the contributor submitted annotation results or, in some cases, based on applying machine prediction to the test questions. As will be described in further detail below, various different types of test questions and corresponding known test answers can be generated based on, respectively, previously distributed queries and the submitted annotation results (or sometimes, machine predictions). Once test questions are dynamically generated in this manner, annotation platform server 116 will distribute job batches to annotator devices associated with contributor users and in which each job batch will include queries from the input data of the annotation job and at least one of these dynamically generated test questions. Depending on the type of generated test question, annotation platform server 116 can assign a test question to the annotator device of the same contributor user from which a query on which the test question was derived was previously sent to. Or, annotation platform server 116 can assign a test question to the annotator device of the different contributor user from which a query on which the test question was derived was previously sent to.

In various embodiments, annotation platform server 116 is configured to present the queries (units of raw input data) and the dynamically generated test questions of a job batch in a user interface at the annotator device of a contributor user in a manner in which a query cannot be distinguished from a test question. In some embodiments, the user interface that is presented at the annotator device is configured with tools that enable the trusted contributor user to input annotations of the selected annotation type on each test question or each query. The contributor user will annotate, at the user interface of the annotator device, each presented query and each test question based on the requested type of annotation (e.g., audio transcription, text labeling, drawing the bounding box around a subject within an image) associated with the annotation job and then submit the annotation results back to annotation platform server 116. After receiving the annotation results submitted by a trusted contributor user for a job batch, annotation platform server 116 is configured to compare the contributor submitted annotation results (submitted test answers) to the test questions of the job batch against the known test answers of those test questions. While all trusted contributor users that are selected to work on an annotation job are assigned the same initial trust level with respect to that job, if the submitted answers to the test questions of the job batch match (e.g., match over a predetermined match threshold) the known test answers, then annotation platform server 116 is configured to update (e.g., increase) the contributor user's trust level with respect to the annotation job. Otherwise, if the submitted annotation results to the test questions of the job batch do not match (e.g., match below or equal to a predetermined match threshold) the known test answers, then annotation platform server 116 is configured to update (e.g., decrease) the contributor user's trust level with respect to the annotation job. As will be described in further detail below, because the contributor submitted test answers are compared to known test answers that are generated from other contributor submitted annotation results to queries, the comparison/evaluation of submitted answers checks for consistency, and for which consistency will result in the submitted answer being deemed correct. As will be described in further detail below, in some embodiments, because a dynamically generated test question is generated from a previous annotation result that was submitted by another contributor user to an assigned query, whether the target contributor user that had received the test question (a contributor user that is assigned a test question can sometimes be referred to as a “target contributor user”) had answered the test question correctly or not could affect his or her trust level as well as the trust level of the other contributor user. Annotation platform server 116 is configured to determine whether a contributor user's updated trust level with respect to the annotation job falls below a trust level threshold. If the contributor user's updated trust level falls below the trust level threshold, annotation platform server 116 is configured to perform an action with respect to the contributor user that is to reduce the contributor user's influence on the annotation job. For example, the action that annotation platform server 116 can perform is to omit distributing a subsequent job batch from the annotation job to the contributor user whose trust level for this annotation job has fallen below the trust level threshold, which effectively removes the contributor user from the annotation job. However, if the contributor user's updated trust level meets or exceeds the trust level threshold, annotation platform server 116 is configured to distribute a subsequent job batch from the annotation job to the annotator device of the contributor user.

Annotation platform server 116 is configured to aggregate the submitted annotation results corresponding to each query (unit of the raw input data) that is received from one or more annotator devices to obtain combined annotation results for that unit of raw input data. Aggregating multiple annotation results corresponding to a query data can improve the accuracy of the annotation over a single contributor user's submitted annotation result. In various embodiments, annotation platform server 116 is configured to generate an aggregate annotation report that includes, for each query of the annotation job, at least the aggregated annotation result. Annotation platform server 116 is configured to send the aggregate annotation report corresponding to the annotation job back to the annotation job management device from which the annotation job was received. In some embodiments, the aggregate annotation report comprises a graphical representation. In some embodiments, the aggregate annotation report comprises a JSON file. In some embodiments, the annotation job management device that receives the aggregate annotation report is configured to input at least a portion of the report as training data into a new or existing machine learning model to train the model to better automatically annotate subsequent input data.

As described with system 100 of FIG. 1 and in further detail below, an annotation job with raw input data to be annotated can be efficiently distributed to a vast number of annotator devices. Manually generated test questions and corresponding test answers do not need to be prepared in advance and used to perform quality control on contributors that are working in an annotation job. Instead, test questions can be dynamically and continuously generated while contributors are working on annotating queries from an annotation job based on the annotation results that are submitted by the contributors. As contributors receive job batches associated with an annotation job over time, the body of submitted annotation results will grow and therefore provide a rich source to use to dynamically generate new test questions. Because more than one pair of test questions and known test answers can be generated from a pair of query and submitted annotation results, the number of dynamically generated test questions can grow faster than the number of submitted annotation results, which will guarantee that the quality control process of contributor users will never run out of test questions. The machine generated test questions that are associated with the annotation job can be provided to the contributor users to ensure that the quality and accuracy of the contributor users' annotation results are programmatically maintained without requiring manual review of each contributor user's annotation results.

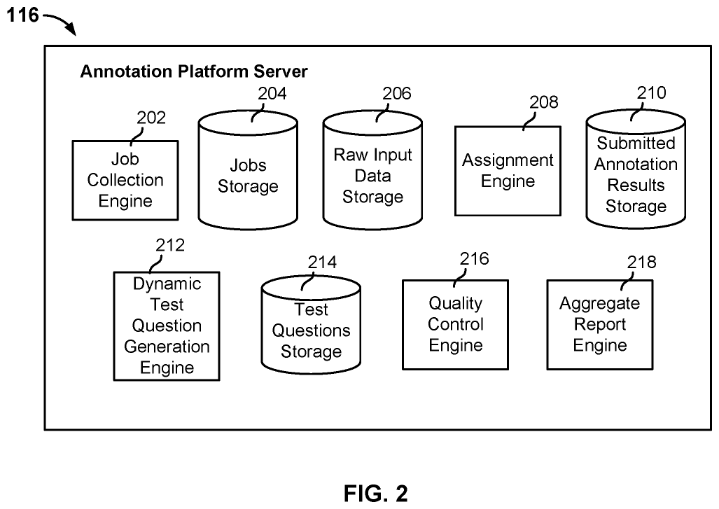

FIG. 2 is a diagram showing an example of an annotation platform server. In some embodiments, annotation platform server 116 of FIG. 1 may be implemented using the example annotation platform server of FIG. 2. In FIG. 2, the example of the annotation platform server includes job collection engine 202, jobs storage 204, raw input data storage 206, assignment engine 208, submitted annotation results storage 210, dynamic test question generation engine 212, test questions storage 214, quality control engine 216, and aggregate report engine 218. Each of job collection engine 202, assignment engine 208, dynamic test question generation engine 212, quality control engine 216, and aggregate report engine 218 may be implemented using one or both of hardware and software. Each of jobs storage 204, raw input data storage 206, submitted annotation results storage 210, and test questions storage 214 may be implemented using one or more databases and/or other types of storage media.

Job collection engine 202 is configured to collect information pertaining to annotation jobs. In some embodiments, job collection engine 202 is configured to provide a user interface to an annotation job creator user at that user's corresponding annotation job management device. The user interface would enable the annotation job creator user to submit information pertaining to a new or an existing annotation job to job collection engine 202. Examples of information pertaining to a new or an existing annotation job may include at least a set of raw input data, a selected annotation type, and contributor user criteria. In some embodiments, the raw input data comprises text data, image data, audio data, point cloud data, video data or other media content. In some embodiments, if the raw input is not already segmented into discrete units, job collection engine 202 is configured to segment the raw input data into discrete units (which are sometime referred to as “queries”). In some embodiments, the contributor user criteria that is received by job collection engine 202 are associated with desired contributor users to whom the raw input data is to be distributed for the purposes of performing annotations. After receiving information pertaining to an annotation job from an annotation job management device, job collection engine 202 is configured to store (e.g., unique) identifying information associated with the annotation job at jobs storage 204. Furthermore, job collection engine 202 is configured to store the raw input data associated with the annotation job at raw input data storage 206. In some embodiments, job collection engine 202 is further configured to keep track of the current status of the annotation job such as, for example, which queries (units of the raw input data) have been annotated by one or more contributor users and how each test question (which are to be dynamically generated based on contributed submitted annotation results associated with an annotation job, as described further below) has been answered by one or more contributor users. In some embodiments, job collection engine 202 is configured to present a user interface at the annotation job management device describing the current status of the annotation job.

Raw input data storage 206 is configured to store the raw input data associated with one or more annotation jobs for which data is stored at jobs storage 204. In some embodiments, the raw input data associated with annotation jobs for which information is stored at jobs storage 204 is not stored at raw input data storage 206 but is rather stored at a third-party repository that is accessible by the annotation platform server. For example, raw text input data stored at raw input data storage 206 is stored as a CSV or another format that can delimit between different queries (e.g., sentences) of the raw text input data. Raw input data storage 206 can store raw input data of different data types (e.g., text, image, audio, video, or other media content).

Prior to assignment engine 208 distributing job batches with queries of input data from an annotation job to the annotator devices of selected contributor users, in some embodiments, quality control engine 216 is configured to screen for high-quality contributor users to work on an annotation job using pre-generated test questions associated with the annotation job. In some embodiments, after a set of candidate contributor users that matches the contributor user criteria of the annotation job is determined, optionally, quality control engine 216 is configured to enter each of the candidate contributor users into a “Quiz Mode” portion of the annotation job by distributing a predetermined number of pre-generated test questions associated with the annotation job to the annotator device of each candidate contributor user. Unlike the dynamically generated test questions that will be generated based on submitted annotation results after the queries from the input data of the annotation job are distributed to the selected contributor users during the “Work Mode,” the test questions that are used to screen candidate contributor users during the “Quiz Mode” could be generated in advance. For example, test questions used in the “Quiz Mode” could be manually generated or generated based on queries and contributor submitted annotation results associated with a completed, historical annotation job. During the “Quiz Mode,” the pre-generated test questions are presented at a user interface at the annotator device of each candidate contributor user and the candidate contributor user is to submit annotations according to the selected annotation type of the annotation job through the user interface back to quality control engine 216. Quality control engine 216 is configured to determine whether the candidate contributor user submitted annotations for each test question are correct by comparing the submitted annotations to the stored known/correct test answer to the test question. If quality control engine 216 determines that the candidate contributor user has correctly answered at least a predetermined number of test questions in the “Quiz Mode,” then quality control engine 216 is configured to determine that the candidate contributor user is a trusted contributor user and can therefore proceed to the “Work Mode” portion of the annotation job. During the “Work Mode” portion of the annotation job, a trusted contributor user will receive queries from the input data associated with the annotation job and also test questions that are dynamically generated based on contributor submitted annotation results to at least some of the queries. In some embodiments, quality control engine 216 is configured to notify assignment engine 208 that a determined trusted contributor user with respect to an annotation job should start to receive job batches associated with the annotation job. Otherwise, if quality control engine 216 determines that the candidate contributor user has correctly answered fewer than the predetermined number of test questions in the “Quiz Mode,” then quality control engine 216 is configured to determine that the candidate contributor user is not a trusted contributor user and therefore cannot proceed to the “Work Mode” portion of the annotation job.

Assignment engine 208 is configured to send job batches associated with an annotation job to trusted contributor users with respect to the annotation job. Specifically, in some embodiments, assignment engine 208 is configured to send job batches to trusted contributor users that have been determined by quality control engine 216 to proceed to the “Work Mode” for the annotation job. Assignment engine 208 is configured to send a job batch to the annotator device of each trusted contributor user. Initially, before assignment engine 208 receives annotation results that have been submitted to queries from annotator devices of contributor users, assignment engine 208 is configured to send job batches with only queries of input data and no test questions. This is because, in various embodiments, the test questions associated with the annotation job are dynamically generated by dynamic test question generation engine 212 based on submitted annotation results to the queries of input data from the annotation job and when such submitted annotation results are not yet available, dynamic test question generation engine 212 will need to wait until some annotation results are submitted for already distributed job batches before it can generate test questions. After assignment engine 208 receives, from annotator devices, annotation results to queries from distributed job batches, assignment engine 208 is configured to store such submitted annotation results and identifying information associated with the associated annotation job and trusted contributor users that had submitted them in submitted annotation results storage 210. As soon as submitted annotation results associated with the annotation job are received, assignment engine 208 can send an indication to dynamic test question generation engine 212 to prompt dynamic test question generation engine 212 to start dynamically generating test questions for the annotation job based on the received submitted annotation results so far, which is described below. Dynamic test question generation engine 212 can store the generated test questions at test questions storage 214.

Dynamic test question generation engine 212 is configured to dynamically generate, for the annotation job, test questions and known/correct answers based on annotation results that have been submitted for queries by trusted contributor users working on the annotation job. In various embodiments, dynamic test question generation engine 212 is configured to generate a test question based on at least one query for which an annotation result has been submitted by a trusted contributor user. In some embodiments, dynamic test question generation engine 212 is configured to manipulate the at least one query and then determine the manipulated result as the test question. In various embodiments, for such a test question, dynamic test question generation engine 212 is configured to generate a corresponding known/correct answer (which is also sometimes referred to as the “answer key”) based on at least one contributor submitted annotation result for the query on which the test question was based. A generated test question can be included in a job batch that is distributed by assignment engine 208 to the same contributor that had submitted the annotation result that was used to generate the known/correct answer to the test question (that was derived from a query for which that submitted annotation result was submitted). Alternatively, a generated test question can be included in a job batch that is distributed by assignment engine 208 to a contributor that is different than the contributor that had submitted the annotation result and was used to generate the known/correct answer to the test question (that was derived from a query for which that submitted annotation result was submitted). A first example type of a dynamically generated test question is referred to as the “self-consistency test” and in which a target contributor user is provided a test question that is generated based on a query that was previously provided to him/her and the test question's known/correct action is an annotation result that was previously submitted by that same contributor user to the query. A second type of a dynamically generated test question is referred to as the “cross-consistency test” and in which a target contributor user is provided a test question that is generated based on a query that was previously provided to another contributor user and the test question's known/correct action is an annotation result that was previously submitted by that other contributor user to the query. A third type of a dynamically generated test question is referred to as the “manipulated consistency test” and in which a target contributor user is provided a test question that is generated based on a manipulation of a query that was previously provided to him/her and the test question's known/correct action is an annotation result that was previously submitted by that same contributor user to the query (or the known/correct answer is a machine predicted annotation to the manipulation of the query). A fourth type of a dynamically generated test question is referred to as the “manipulated combination consistency test” and in which a target contributor user is provided a test question that is generated based on a manipulated combination of at least two queries that were previously provided to at least one contributor user and the test question's known/correct action is a combination of the annotation results that were previously submitted by the at least one contributor user to the at least two queries (or the known/correct answer is a machine predicted annotation to the manipulated combination of the at least two queries). The generation of each of the four example types of test questions will be described in further detail below. Dynamic test question generation engine 212 can store the generated test questions at test questions storage 214. As more submitted annotation results to queries are received by assignment engine 208, more test questions can be dynamically generated from the submitted annotations results, which results in a very scalable technique for generating more test questions in real-time, while an annotation job is being worked on by a set of trusted contributor users.

Once dynamically generated test questions are generated for the annotation job and stored at test questions storage 214, assignment engine 208 is configured to send job batches to trusted contributor users associated with the annotation job and where each job batch includes both queries from the input data of the annotation job as well as such test questions. At the annotator device of the trusted contributed user, the queries (units of raw input data) and test questions are presented similarly at a user interface such that the contributor user is not able to discern a difference between them. The trusted contributor user submits annotations to the presented queries and test questions in the user interface presented at the annotator device and the submitted annotation results are sent back to assignment engine 208. Assignment engine 208 is configured to send the submitted annotation results corresponding to the test questions of the job batch to quality control engine 216. To determine whether a target contributor user that had received a dynamically generated test question submitted the correct answer, quality control engine 216 is configured to compare the contributor's submitted answer against the test question's known/correct answer. If the submitted answer matches (e.g., above a similarity threshold) the known/correct answer, then the submitted answer is determined to be consistent with the known/correct answer and is therefore correct. Then, based on whether the submitted answer that was submitted by the target contributor user was correct or not, quality control engine 216 is configured to update the target contributor user's trust level for the annotation job. For example, quality control engine 216 is configured to increase the target contributor user's trust level with respect to the annotation job if the target contributor answered a test question correctly and to decrease the target contributor user's trust level with respect to the annotation job if the contributor answered the test question incorrectly. Quality control engine 216 is then configured to compare the updated trust level with respect to the annotation job to a predetermined trust level threshold. If the trusted contributor user's trust level with respect to the annotation job falls below the predetermined trust level threshold, then the trusted contributor user's work quality is no longer considered acceptable and quality control engine 216 is configured to perform an action with respect that contributor. In a first example, the action is to notify assignment engine 208 to no longer send a subsequent job batch associated with the annotation job to the annotator device of that contributor. In a second example, the action is to discard annotation results submitted by that contributor to queries that were included in the current job batch or all job batches worked on so far for the given annotation job (so that the contributor's submitted annotations are not included in the aggregate annotation report that is generated for the annotation job). As such, assignment engine 208 is configured to send a subsequent job batch for the annotation job only to trusted contributor users with respect to the annotation job whose trust levels for the annotation job remain equal or greater than a predetermined trust level threshold.

In some embodiments, quality control engine 216 is configured to maintain profiles (e.g., including historical trust levels) associated with contributor users. For example, quality control engine 216 can recommend a contributor user to an annotation job based on that user's historical trust level in similar annotation jobs.

In some embodiments, quality control engine 216 is configured to perform validation on submitted annotation results for job batches. For example, validation may include determining grammar errors, spelling errors, gibberish submissions, and formatting errors. If a submitted piece of annotation cannot be validated, a corresponding prompt may be sent to the annotator device of the relevant contributor to invite the contributor to submit an updated piece of annotation result.

Aggregate report engine 218 is configured to generate an aggregate annotation report corresponding to an annotation job for which data is stored at jobs storage 204 based on annotation results that have been received from annotator devices for the raw input data associated with the annotation job. In some embodiments, aggregate report engine 218 is configured to collect all the annotation results that have been collected by assignment engine 208 and/or stored at submitted annotation results storage 210 for each query (unit of the raw input data) associated with the annotation job. In some embodiments, annotation results that were submitted by a contributor user whose trust level fell below the predetermined trust level threshold are marked as such in submitted annotation results storage 210 and therefore excluded, not used, discarded, or otherwise ignored by aggregate report engine 218 in generating the aggregate annotation report for the annotation job. In some embodiments, for each query associated with the annotation job, aggregate report engine 218 is configured to group together all the received annotation results with respect to that query. Then, for each query, aggregate report engine 218 is configured to determine an aggregated annotation from the group of annotation results associated with that query. For example, the aggregated annotation corresponding to a query is determined as the most frequently occurring annotation result that had been submitted for the query. As such, in various embodiments, the aggregate annotation report corresponding to the annotation job comprises, for each query associated with the annotation job, aggregated annotations determined based on aggregated annotation results corresponding to each query. In some embodiments, submitted annotation results storage 210 is configured to send the aggregate annotation report corresponding to the annotation job to the annotation job management device from which the annotation job was received. In some embodiments, submitted annotation results storage 210 is configured to generate a visual presentation based on the aggregate annotation report corresponding to the annotation job and then cause the visual presentation to be presented at the annotation job management device from which the annotation job was received. The annotation job creator user that had created the annotation job can then use the received aggregate annotation report as training data to build a new or update an existing machine learning model.

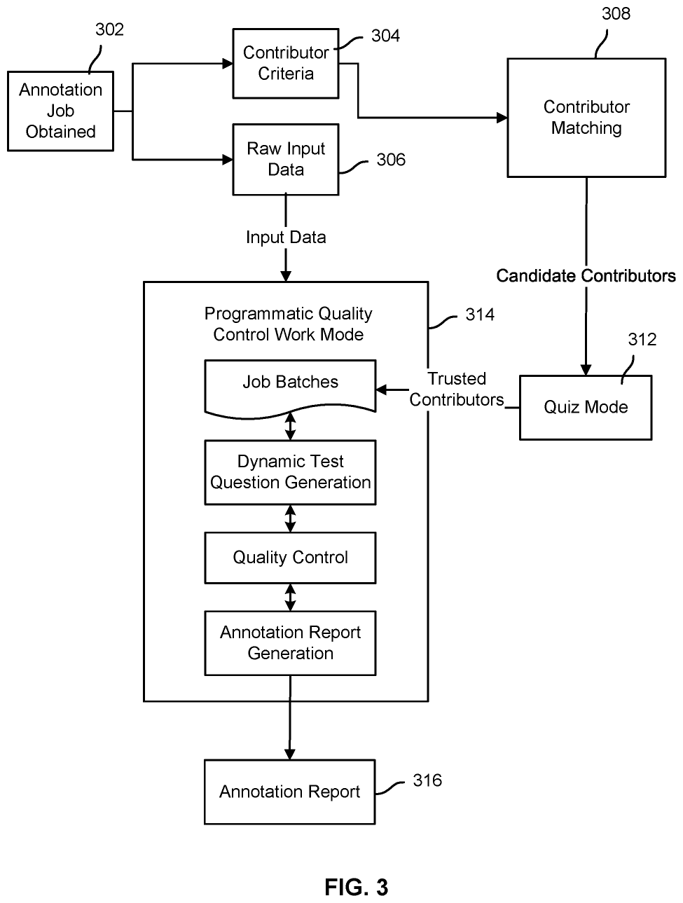

FIG. 3 is a schematic diagram showing an example of dynamic test generation and quality control of submitted annotations as performed by an annotation platform server in accordance with embodiments described herein. An annotation job is obtained at 302 from an annotation job creator user from an annotation job management device. The annotation job includes contributor criteria 304 and raw input data 306. Contributor criteria 304 is used in contributor matching 308 in which contributor criteria is compared against the profiles of available contributor users to determine matching, candidate contributor users. Optionally, the candidate contributor users are presented, at annotator devices, with a quiz of pre-generated test questions associated with the annotation job at quiz mode 312. Those candidate contributor users that pass the quiz are then considered trusted contributor users and proceed to programmatic quality control work mode 314. Initially, programmatic quality control work mode 314 sends job batches comprising only queries of raw input data to the annotator device of each trusted contributor user. As submitted annotation results to the distributed queries are received from the annotator devices of trusted contributor users, programmatic quality control work mode 314 uses the queries and corresponding submitted annotation results to dynamically generate test questions. In various embodiments, each dynamically generated test question is based on at least one query for which a submitted annotation result has been received and the corresponding known/correct answer to that test question is determined based on the submitted annotation results of the at least one query. Once such test questions have been dynamically generated, programmatic quality control work mode 314 is configured to send job batches with a mix of queries of the raw input data and also the dynamically generated test questions. Programmatic quality control work mode 314 is configured to determine whether a target contributor user had correctly answered a received test question by determining whether the contributor user's submitted answer matches the known/correct answer of the test question. In various embodiments, programmatic quality control work mode 314 is configured to increase the target contributor user's trust level with respect to the annotation job when the target contributor user's submitted answer matches the known/correct answer of the test question and decrease the target contributor user's trust level with respect to the annotation job when the target contributor user's submitted answer does not match the known/correct answer of the test question. Programmatic quality control work mode 314 is then configured to perform quality control on the submitted annotation results by contributor users by monitoring the dynamically updated respective trust levels associated with the contributor users. For example, if a contributor user's updated trust level with respect to the annotation job falls below a threshold due to the contributor user answering test questions incorrectly, then the contributor user is prevented from working on subsequent job batches associated with the annotation job and/or the submitted annotation results of that contributor to queries of the annotation job are excluded from the annotation report to be generated for the annotation job. Programmatic quality control work mode 314 also aggregates the annotation results submitted by the one or more trusted contributor users associated with the annotation job to generate annotation report 316 corresponding to the annotation job. Annotation report 316 is then output to the annotation job management device of the annotation job creator user that had submitted the annotation job.

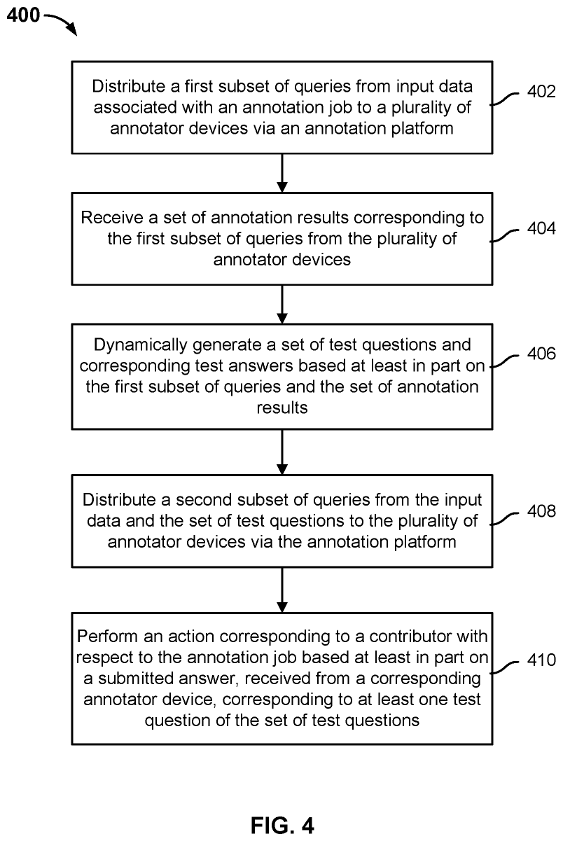

FIG. 4 is a flow diagram showing an embodiment of a process for dynamic test question generation for automatic quality control of submitted annotations. In some embodiments, process 400 can be implemented by an annotation platform server such as annotation platform server 116 of FIG. 1. In some embodiments, process 400 can be implemented by programmatic quality control work mode 314 of FIG. 3.

At 402, a first subset of queries from input data associated with an annotation job is distributed to a plurality of annotator devices via an annotation platform. The input data associated with the annotation job could be text, images, audio, video, point cloud, or other media. The annotation job is also associated with a selected annotation type, which is the type of annotation that is to be performed by contributor users on the input data. Example annotation types include audio transcription of audio segments, text labeling (e.g., part of speech, classification) of sentences, image labeling of subjects that are within images, drawing the bounding box around a subject within an image, and point cloud labeling of subjects that appear in a point cloud. Only queries (units of the input data that are to be annotated) that are associated with an annotation job are included in job batches that are initially distributed to (trusted) contributor users that have been selected to work on the job. Each contributor user is to perform the selected annotation type to each query that is distributed to him or her via an annotation tool/user interface that is presented at a corresponding annotation device.

At 404, a set of annotation results corresponding to the first subset of queries is received from the plurality of annotator devices.

At 406, a set of test questions and corresponding test answers are dynamically generated based at least in part on the first subset of queries and the set of annotation results. In various embodiments, test questions comprising one or more types are dynamically generated based on the distributed queries and their corresponding annotation results that have been submitted by the contributor users that had performed the annotations. In some embodiments, a test question is dynamically generated from one or more queries for which a respective submitted annotation result has been received. The known/correct answer/answer key to that test question would then be dynamically generated based at least in part on the respective submitted annotation results.

Because the queries of the input data are generally not annotated and are therefore not associated with known/correct annotations, the test questions that are dynamically generated based on contributor submitted annotation results test for consistency between different submissions of annotations, which is used as a proxy for correctness. This is because, generally, consistency of annotation results among different instances of submissions by the same contributor user or between submissions by different contributor users represents a consensus of judgment, which can be relied on for correctness.

At 408, a second subset of queries from the input data and the set of test questions are distributed to the plurality of annotator devices via the annotation platform. After test questions and their respective test answers have been dynamically generated, a mix of test questions and queries from the input data are included in job batches that are distributed to the contributor users on the annotation job. Whether data that is to be annotated is a test question or a query is not indicated/presented to the contributor user and it is intended for the presentation of the test question and the query to be indistinguishable.

At 410, an action corresponding to a contributor with respect to the annotation job is performed based at least in part on a submitted answer received from a corresponding annotator device to at least one test question of the set of test questions. A contributor user's submitted annotation result to a test question is then compared to the test question's known/correct answer to perform quality control on the contributor's work. A contributor user's submitted annotation result to a query is potentially included in an annotation report, a programmatic aggregation of the annotation results that have been received from a contributor user who met the required threshold level, corresponding to the annotation job. As such, as test answers/annotation results to test questions are received from a contributor user, the submitted answers are compared to the known/correct test answers. If the contributor user's submitted answer matches the known/correct test answer, then the contributor user's trust level with respect to the annotation job is increased. Otherwise, if the contributor user's submitted answer does not match the known/correct test answer, then the contributor user's trust level with respect to the annotation job is decreased. In the event that the contributor user's trust level with respect to the annotation job falls below a threshold and therefore, it is considered that the contributor's work quality on the annotation job is less than acceptable, then an action is performed with respect to the contributor to decrease the contributor's influence/involvement on the outcome of the annotation job. One example action is that the contributor user is prevented from receiving subsequent job batches associated with the annotation job. Another example action is that the annotation results that have been submitted by that contributor user are to be excluded from being aggregated into the annotation report that is to be generated for the annotation job.

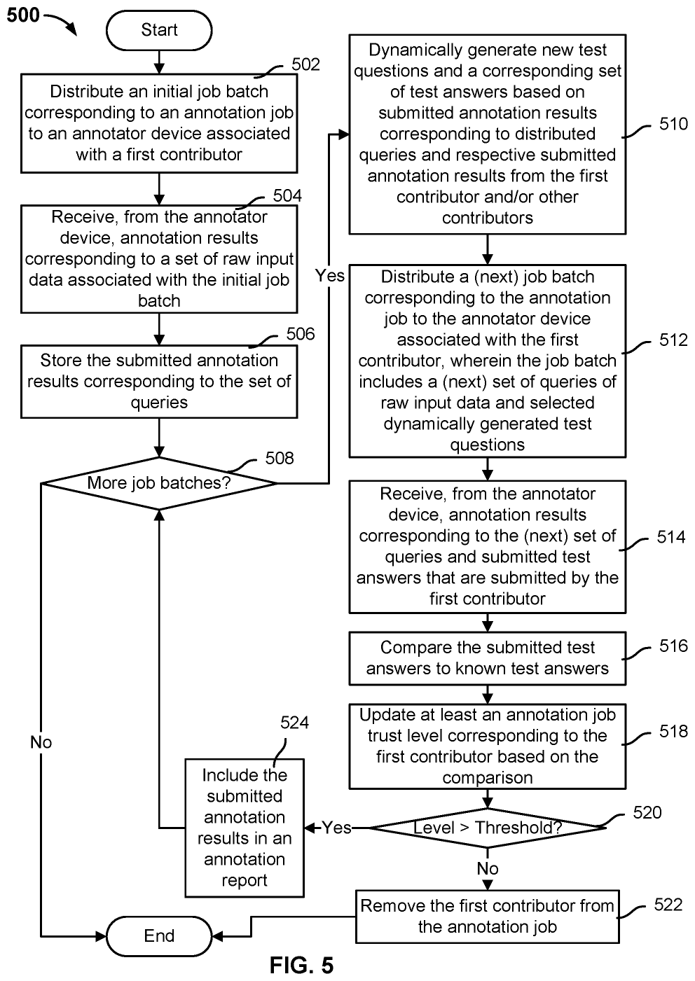

FIG. 5 is a flow diagram showing an example of a process for dynamic test question generation for automatic quality control of submitted annotations. In some embodiments, process 500 can be implemented by an annotation platform server such as annotation platform server 116 of FIG. 1. In some embodiments, process 400 of FIG. 4 may be implemented, at least in part, using process 500.

At 502, an initial job batch corresponding to an annotation job is distributed to an annotator device associated with a first contributor. An initial job batch that includes only queries of input data associated with the annotation job is sent to the annotator device of a first (trusted) contributor user that has been selected to work on the annotation job.

At 504, annotation results corresponding to a set of raw input data associated with the initial job batch is received from the annotator device. After the first contributor user has performed the selected type of annotation that is associated with the annotation job on the received queries in the initial job batch, then the first contributor user submits the annotation results via his or her annotator device.

At 506, the submitted annotation results corresponding to the set of queries are stored.

At 508, whether at least one more job batch is to be distributed to the first contributor is determined. In the event that at least one more job batch is to be distributed to the first contributor, control is transferred to 510. Otherwise, in the event that no further job batches are to be distributed to the first contributor, process 500 ends. In some embodiments, whether another job batch is to be distributed to the first contributor user is determined based on whether the contributor's trust level with respect to the annotation job is equal to or greater than a threshold trust level. In the event that the contributor's trust level with respect to the annotation job is equal to or greater than the threshold trust level, then a next job batch is to be distributed to the contributor user. In some embodiments, whether another job batch is to be distributed to the first contributor user is further determined based on whether more queries of the input data need additional annotation results. In the event that there are remaining queries of the input data that need additional annotation results, then a next job batch is to be distributed to the contributor user.

At 510, new test questions and a corresponding set of test answers are dynamically generated based on submitted annotation results corresponding to distributed queries and respective submitted annotation results from the first contributor and/or other contributors. Once submitted annotation results have been received from at least one contributor user that has been selected to work on the annotator job, then test questions and their corresponding test answers can be dynamically generated for the annotation job. Specifically, in some embodiments, a single query, a manipulation of a single query, a combination of two or more queries, and/or a manipulated combination of two or more queries is determined as a test question. Then, a corresponding known/correct test answer to that test question is generated at least in part on the submitted annotation result that is submitted by one or more contributor users to the one or more queries on which the test question was based.

In some embodiments, a query and a contributor's submitted annotation result can be used to generate one or more test questions and corresponding test answers. In some embodiments, a test question whose known/correct answer was generated based on a particular contributor user's submitted annotation result can be distributed to that same contributor user or a different contributor user, depending on its test question type.

At 512, a (next) job batch corresponding to the annotation job is distributed to the annotator device associated with the first contributor, wherein the job batch includes a (next) set of queries of raw input data and selected dynamically generated test questions. After the first contributor user has submitted annotation results to at least one job batch, then subsequent job batches distributed to the annotator device of that contributor user can include a mix of queries of input data and also dynamically generated test questions.

In some embodiments, the types of test questions and the ratio of test questions to queries in one or more subsequent job batches that are distributed to a particular contributor user may dynamically depend on one or more factors. A first example factor is the likelihood of fraudulent behavior. For instance, if the contributor user is submitting annotation results above a threshold speed/rate and/or above a statistical metric (e.g., average) associated with the speed/rate of submissions of other contributor users on the same annotation job, then that contributor user can be assigned test questions associated with types that are more difficult (e.g., test questions comprising a manipulated combination of two or more queries, test questions comprising queries that require multiple annotations) and/or assigned a greater number of test questions relative to queries in the next job batch. This is because a usually high speed/rate of submission of annotation results could be indicative of a bot performing the annotations or a human randomly performing annotations, both of which would be considered fraudulent activity. A second example factor is the historical performance (e.g., trust levels) of the contributor user in previous/completed annotation jobs. For instance, if the contributor user had an average historical trust level corresponding to previous/completed annotation jobs that is lower than the threshold trust level, then that contributor user can be assigned test questions associated with types that are more difficult and/or assigned a greater number of test questions relative to queries in the next job batch because his or her work should be subject to greater quality control. A third example factor is the performance of the contributor user relative to that of peer contributor users on the same annotation job. For instance, if the contributor user's performance (e.g., speed) on submitting annotation results and/or percentage correctness on test questions deviates (e.g., is less than) beyond a predetermined percentage relative to those of his or her peer (e.g., similarly experienced) contributor users on the same annotation job, then the contributor user can be assigned test questions associated with types that are more difficult and/or assigned a greater number of test questions relative to queries in the next job batch because his or her work should be subject to greater quality control.

At 514, annotation results corresponding to the (next) set of queries and submitted test answers that are submitted by the first contributor are received from the annotator device. The annotation submissions from the first contributor user to the queries and test questions of the recent job batch are received from the annotator device of the contributor. The submitted annotation results to the queries are collected and are to be included in the annotation report that is to be generated for the annotation job, pending the first contributor user's overall performance on test questions with respect to the annotation job as represented by the contributor's dynamically updated trust level.

At 516, the submitted test answers are compared to known test answers. Each of the first contributor user's submitted test answer for a test question is compared to the known/correct test answer for that test question. If the first contributor user's submitted test answer has a similarity to the known/correct test answer for that test question that is greater than a threshold similarity, then the contributor user is determined to have answered that test question correctly. Otherwise, if the first contributor user's submitted test answer has a similarity to the known/correct test answer for that test question that is equal to or less than a threshold similarity, then the contributor user is determined to have answered that test question incorrectly.

How the contributor user's submitted test answer for a test question is compared to the known/correct test answer for that test question is dependent on the selected annotation type associated with the annotation job. In a first example, if the selected annotation type were parts of speech labeling on a sentence, then the annotated label(s) of the submitted test answer could be compared to the label(s) of the test answer to determine a percentage of similarity of the labels and their locations within the text. In a second example, if the selected annotation type were parts of a bounding box label on image data, then the annotated bounding box(es) of the submitted test answer could be compared to the bounding box(es) of the test answer to determine a percentage of similarity between the bounding boxes' sizes and their locations.

At 518, at least an annotation job trust level corresponding to the first contributor is updated based on the comparison. In various embodiments, if the first contributor user answers a test question correctly, then his or her trust level for the annotation job is increased. Also, if the first contributor user answers a test question incorrectly, then his or her trust level for the annotation job is decreased. In some embodiments, how much the first contributor user's trust level is increased or decreased is dependent on the difficulty level associated with the test question and a greater increase or decrease is provided for an easier test question than for a more difficult test question. For example, a test question that combines two or more queries and/or a test question that includes more than one annotation as the correct answer can be determined to be more difficult than a test question that is generated based on a single query and/or includes only a single annotation as the correct answer.

In some embodiments, depending on whether the first contributor user answers a test question correctly, the trust level of a second contributor user whose submitted annotation result was used to determine the known/correct test answer to that test question is also correspondingly updated. For example, a test question was dynamically generated based on a query and the corresponding test answer was generated based on contributor Alice's submitted annotation result to that query. If contributor Bob answers the test question correctly, then both his and Alice's trust levels for the current annotation job would increase (by the same or a different amount, which is configurable). But if contributor Bob answers the test question incorrectly, then both his and Alice's trust levels for the current annotation job would decrease (by the same or a different amount, which is configurable).

At 520, whether the first contributor's annotation job trust level is greater than a threshold trust level is determined. In the event that the first contributor's annotation job trust level is greater than a threshold trust level, control is transferred to 524. Otherwise, in the event that the first contributor's annotation job trust level is not greater than a threshold trust level, control is transferred to 522. In various embodiments, quality control is performed on contributor users that have been selected to work on the annotation job by updating and monitoring their performance on annotations based on their performance on dynamically generated test questions. In some embodiments, after the first contributor user's performance on the test questions of a job batch is programmatically evaluated and his or her trust level adjusted accordingly, whether that contributor user is to continue to work on the same annotation job by virtue of being provided a next job batch is dependent on that contributor user's current trust level. If the first contributor user's current trust level falls below a threshold, then it is determined that the contributor's work/annotations are no longer trustworthy or of acceptable quality.

At 522, the first contributor is removed from the annotation job. In some embodiments, the contributor user is temporarily removed from the annotation job until a human reviewer reviews the contributor's submitted annotation results for a desired quality metric. After the human reviewer approves the contributor to return to the annotation job, the contributor is able to receive an additional job batch (e.g., at 512, but this path is not shown in FIG. 5). In some embodiments, the contributor user is permanently removed from the annotation job. For example, permanently removing the contributor user from the annotation job may include no longer distributing new job batches to the annotator device of the contributor. In another example, permanently removing the contributor user from the annotation job may include no longer distributing new job batches to the annotator device of the contributor and excluding all annotation results that have been submitted by the contributor for the annotation job to be excluded from the annotation report that is to be aggregated/compiled from the annotation results submitted by all contributors (e.g., and whose trust levels have been maintained to meet or exceed the threshold trust level) on the annotation job.

At 524, the submitted annotation results are included in the annotation report. In some embodiments, if the first contributor user's trust level with respect to the annotation job is maintained at or above the threshold trust level, then the contributor's submitted annotation results are determined to be of an acceptable quality and should be included in the annotation report that is to be generated at the completion of the annotation job.

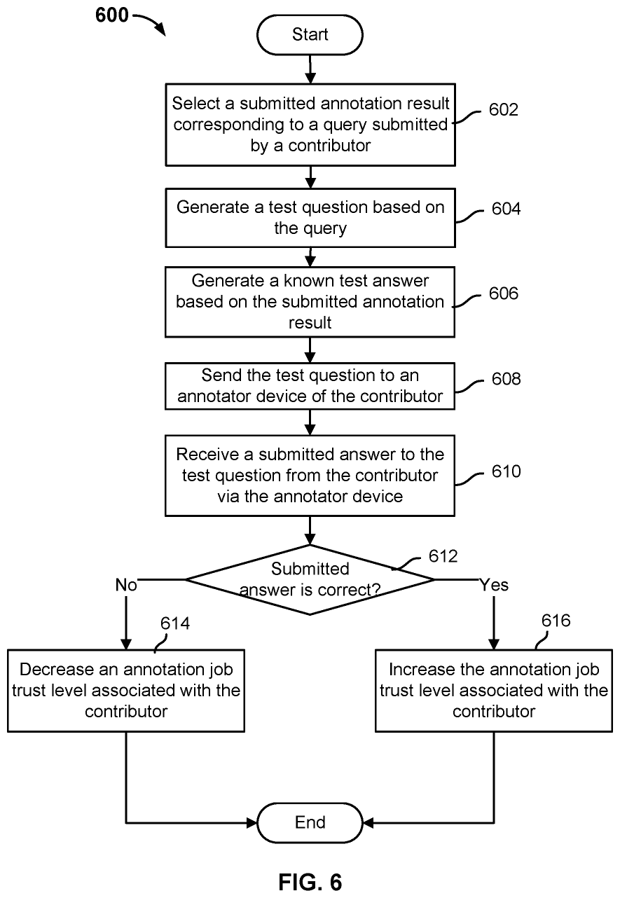

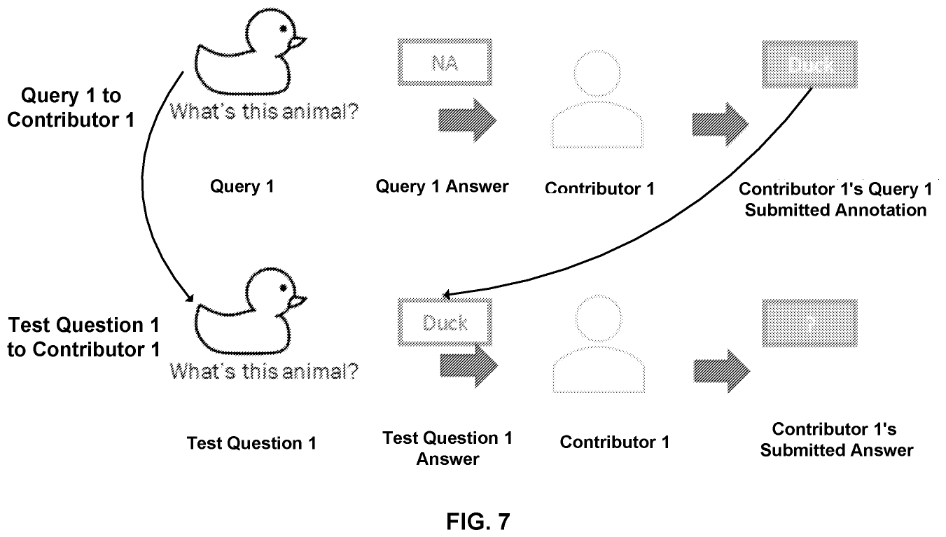

FIGS. 6 and 7 describe examples of dynamically generating a first example type of test question that is referred to as the “self-consistency test.”

FIG. 6 is a flow diagram showing an example of a process for dynamically generating the self-consistency type of test question. In some embodiments, process 600 can be implemented by an annotation platform server such as annotation platform server 116 of FIG. 1. In some embodiments, step 510 of process 500 of FIG. 5 may be implemented, at least in part, using process 600.

At 602, a submitted annotation result corresponding to a query submitted by a contributor is selected. In some embodiments, a query in an annotation job for which a contributor user had submitted an annotation result is selected based on selection criteria. For example, a query can be selected to be the basis for a test question for a contributor user if the contributor had responded to the query under a predetermined length of time after it was presented at a user interface for the contributor at his or her corresponding annotator device. For example, the quick speed at which the contributor user had performed annotations on a query may be indicative of fraudulent activity and/or carelessness.

At 604, a test question is generated based on the query. In the self-consistency test, the original query is used as a test question without modification.

At 606, a known test answer is dynamically generated based on the submitted annotation result. In the self-consistency test, the contributor's original submitted annotation result to the query selected at step 602 is used as a known/correct test answer to the test question. At 608, the test question is sent to an annotator device of the contributor.

At 610, a submitted answer to the test question is received from the annotator device.

At 612, whether the submitted answer is correct is determined. In the event that the submitted answer is correct, control is transferred to 616. Otherwise, in the event that the submitted answer is not correct, control is transferred to 614. The contributor user's submitted answer to the test question is compared to the known/correct test answer to determine whether the match/similarity is greater than a threshold. In the self-consistency test, the contributor is tested on whether he or she can consistently perform the same annotations on the same presented query/test question.

At 614, an annotation job trust level associated with the contributor is decreased.

In the event that the contributor has not consistently annotated the same query across different instances (the first instance when it was a query and the second instance when it was a test question), then the contributor is penalized for his or her lack of consistency with a decrease to their trust level with respect to the current annotation job.

At 616, the annotation job trust level associated with the contributor is increased. In the event that the contributor has consistently annotated the same query across different instances (the first instance when it was a query and the second instance when it was a test question), then the contributor is rewarded for his or her consistency with an increase to their trust level with respect to the current annotation job.

FIG. 7 is a diagram showing an example of the generation and the assignment of a self-consistency type of test question. In the example of FIG. 7, the selected annotation type associated with the annotation job is to label an animal that appears within an image. As shown in FIG. 7, Query 1 comprising an image of a duck is sent to the annotator device of Contributor 1. Because Query 1 is a unit of input data associated with the annotation job that is to be annotated, Query 1 does not come with a correct answer. After receiving Query 1, Contributor 1 submits a submitted annotation to the image, which is the label of “Duck.” Query 1 is then selected to become the basis of a self-consistency test and so a test question, Test Question 1, that is equivalent to Query 1 is generated. The known/correct test answer to Test Question 1 is then generated to be the equivalent to Contributor 1's submitted annotation to the image, “Duck.” Test Question 1 is then assigned to Contributor 1 to determine whether Contributor 1 can submit a subsequently consistent annotation result (submitted answer) to this image. If the Contributor 1 does submit a consistent annotation result (“Duck”), then Contributor 1 is deemed consistent and is rewarded with an increase in his or her trust level with respect to the annotation job.

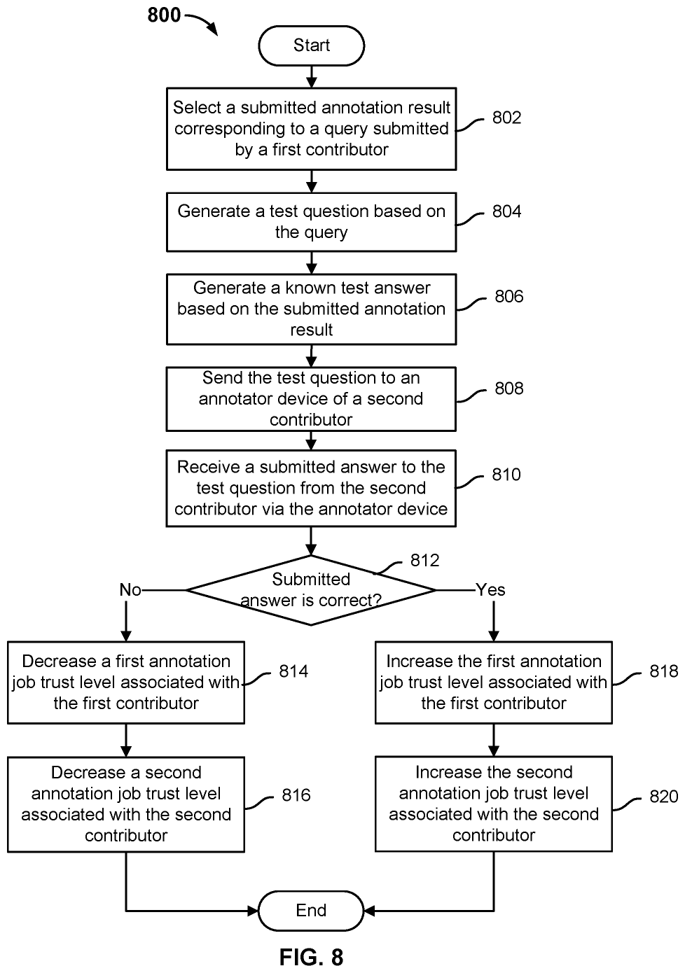

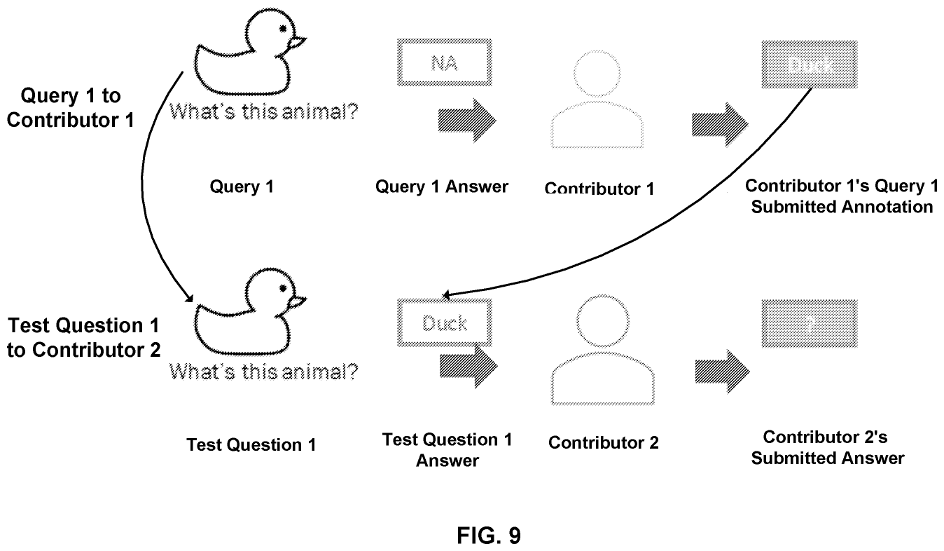

FIGS. 8 and 9 describe examples of dynamically generating a second example type of test question that is referred to as the “cross-consistency test.”

FIG. 8 is a flow diagram showing an example of a process for dynamically generating the cross-consistency type of test question. In some embodiments, process 800 can be implemented by an annotation platform server such as annotation platform server 116 of FIG. 1. In some embodiments, step 510 of process 500 of FIG. 5 may be implemented, at least in part, using process 800.

At 802, a submitted annotation result corresponding to a query submitted by a first contributor is selected. In some embodiments, a query in an annotation job for which a contributor user had submitted an annotation result is selected based on selection criteria. For example, a query for which an annotation result has been received from a first contributor can be selected to be the basis for a test question for a second contributor user if the second contributor had responded to a different query under a predetermined length of time after it was presented at a user interface for the second contributor at his or her corresponding annotator device. For example, the quick speed at which the contributor user had performed annotations on a query may be indicative of fraudulent activity and/or carelessness.

At 804, a test question is generated based on the query. In the cross-consistency test, the original query is used as a test question without modification.

At 806, a known test answer is dynamically generated based on the submitted annotation result. In the cross-consistency test, the first contributor's original submitted annotation result to the query selected at step 802 is used as a known/correct test answer to the test question.

At 808, the test question is sent to an annotator device of a second contributor.

Unlike the self-consistency test that is described in FIGS. 6 and 7, above, a cross-consistency test question is sent to a different contributor than the one from which its corresponding test answer was received.

At 810, a submitted answer to the test question is received from the second contributor user via the annotator device.

At 812, whether the submitted answer is correct is determined. In the event that the submitted answer is correct, control is transferred to 818. Otherwise, in the event that the submitted answer is not correct, control is transferred to 814. The second contributor user's submitted answer to the test question is compared to the known/correct test answer to determine whether the match/similarity is greater than a threshold. In the cross-consistency test, the second/target contributor is tested on whether he or she can consistently perform the same annotations as another contributor on the same presented query/test question.

At 814, a first annotation job trust level associated with the first contributor is decreased. In the event that the second contributor has not consistently annotated the same query as the first contributor, then the first contributor is also penalized for the lack of consistency with a decrease to their trust level with respect to the current annotation job. The lack of consistency across two contributors' performance on the same query could indicate a lack of reliability on the part of each contributor.

At 816, a second annotation job trust level associated with the second contributor is decreased. In the event that the second contributor has not consistently annotated the same query as the first contributor, then the second contributor is penalized for the lack of consistency with a decrease to their trust level with respect to the current annotation job.

At 818, the first annotation job trust level associated with the first contributor is increased. In the event that the second contributor consistently annotated the same query as the first contributor, then the first contributor is rewarded for the validation/consistency that is provided by the second contributor's submitted answer to the test answer with an increase to the first contributor's trust level with respect to the current annotation job.

At 820, the second annotation job trust level associated with the second contributor is increased. In the event that the second contributor consistently annotated the same query as the first contributor, then the second contributor is rewarded for the consistency of the second contributor's submitted answer with the test answer with an increase to the second contributor's trust level with respect to the current annotation job.

FIG. 9 is a diagram showing an example of the generation and the assignment of a cross-consistency type of test question. In the example of FIG. 9, the selected annotation type associated with the annotation job is to label an animal that appears within an image. As shown in FIG. 9, Query 1 comprising an image of a duck is sent to the annotator device of Contributor 1. Because Query 1 is a unit of input data associated with the annotation job that is to be annotated, Query 1 does not come with a correct answer. After receiving Query 1, Contributor 1 submits a submitted annotation to the image, which is the label of “Duck.” Query 1 is then selected to become the basis of a cross-consistency test and so a test question, Test Question 1, that is equivalent to Query 1 is generated. The known/correct test answer to Test Question 1 is then generated to be the equivalent to Contributor 1's submitted annotation to the image, “Duck.” Test Question 1 is then assigned to a different contributor, Contributor 2, to determine whether Contributor 2 can submit a consistent annotation result (submitted answer) relative to Contributor 1 to this image. If Contributor 2 does submit a consistent annotation result (“Duck”), then Contributor 2 is deemed consistent and is rewarded with an increase in his or her trust level with respect to the annotation job. In some embodiments, if Contributor 2 does submit a consistent annotation result (“Duck”), then Contributor 1 is also rewarded with an increase in his or her trust level with respect to the annotation job.

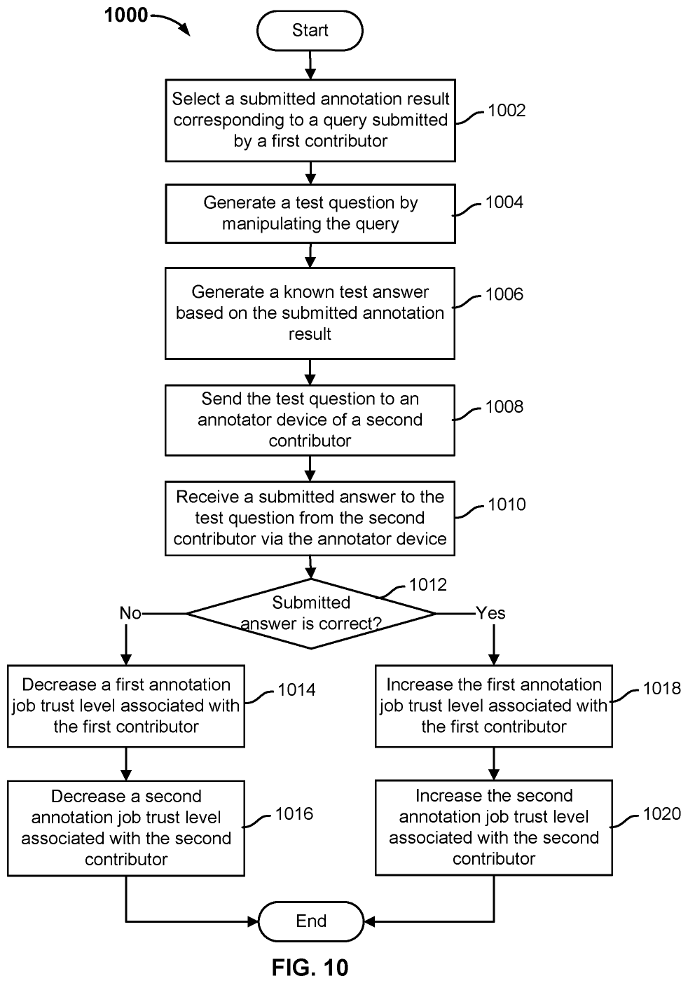

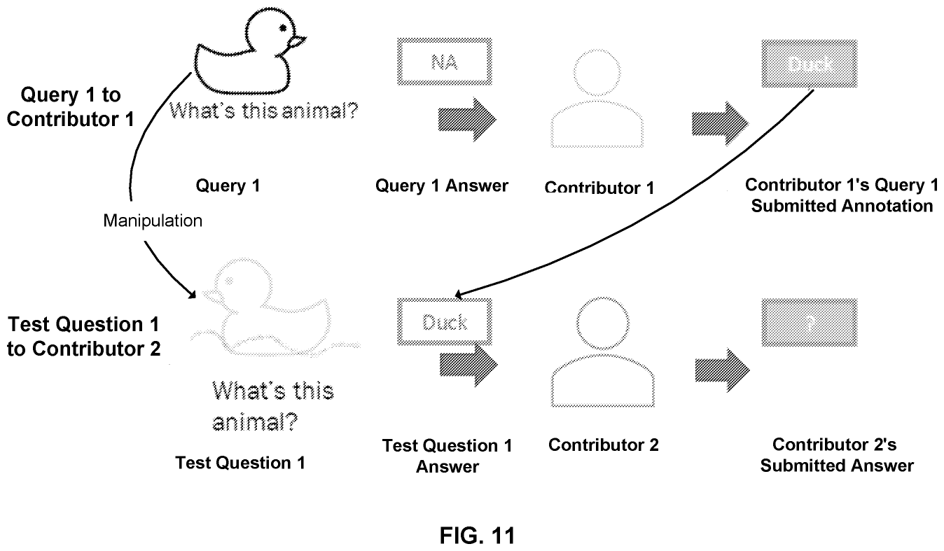

FIGS. 10 and 11 describe examples of dynamically generating a third example type of test question that is referred to as the “manipulated consistency test.”

FIG. 10 is a flow diagram showing an example of a process for dynamically generating the manipulated consistency type of test question. In some embodiments, process 1000 can be implemented by an annotation platform server such as annotation platform server 116 of FIG. 1. In some embodiments, step 510 of process 500 of FIG. 5 may be implemented, at least in part, using process 1000.

At 1002, a submitted annotation result corresponding to a query submitted by a first contributor is selected. In some embodiments, a query in an annotation job for which a contributor user had submitted an annotation result is selected based on selection criteria. For example, a query for which an annotation result has been received from a first contributor can be selected to be the basis for a test question for a second contributor user if the second contributor had responded to a different query under a predetermined length of time after it was presented at a user interface for the second contributor at his or her corresponding annotator device. For example, the quick speed at which the contributor user had performed annotations on a query may be indicative of fraudulent activity and/or carelessness.

At 1004, a test question is generated based on manipulating the query. In the manipulated consistency test, a modified/manipulated version of the query is used as a test question. How the selected query is manipulated depends on the type of data and/or selected annotation type that is associated with the query/input data of the annotation job. In a first example, if the query were text and the selected annotation type is to label parts of speech, then noise comprising additional words could be added to the query. In a second example, if the query were an image and the selected annotation type is to label a subject in the image, then noise comprising image data could be added to the image. In a third example, if the query were an image and the selected annotation type is to label a subject in the image, then the image could be flipped. In a fourth example, if the query were an image and the selected annotation type is to label a subject in the image, then the size of the image could be changed. In a fifth example, if the query were an image and the selected annotation type is to label a subject in the image, then an occlusion can be introduced to cover a portion of the image. In a sixth example, if the query were a point cloud and the selected annotation type is to label a subject in the point cloud, then a portion of the points in the point cloud can be removed.

At 1006, a known test answer is dynamically generated based on the submitted annotation result. Depending on the type of manipulation and the selected annotation type of the annotation job, the known/correct test answer corresponding to the test question could be equivalent to the first contributor's original submitted annotation result to the query selected at step 1002 or a meta annotator program based on the manipulated query/test question. In various embodiments, a “meta annotator program” comprises a computer program that is configured to programmatically generate annotations. In a first example, a meta annotator program can be a machine learning model (e.g., a computer program that “learns” from training data to perform tasks). In a second example, a meta annotator program can be a computer program that is configured to programmatically perform an annotation based on a passed parameter. For instance, a meta annotator computer program is configured to perform an X-pixel offset to the bounding box annotation, and originally the contributor submitted annotation result was (x=10, y=30), but the annotation has now been manipulated to be shifted by N in the x-axis and so the annotation is now at (x=10+N, y=30). This computer program can simply follow the parameter N that is passed along from the combination manipulation program which had full knowledge of the value of N. For example, if the manipulation of the query in the generation of the test question should not change the annotation of the query, then the contributor submitted annotation result can be used as the known/correct test answer. For instance, if the query were an image and the selected annotation type is to label a subject in the image, then a change in size of the image and/or the flipping of the image should not change its annotation result.

While not shown at step 1006, in another example, if the manipulation of the query in the generation of the test question could likely change the annotation of the query, then a meta annotator program that is designed to perform the selected annotation type associated with the annotation is used to output a prediction/classification, which will be used as the known/correct test answer. For instance, if the query were an image and the selected annotation type is to draw a bounding box around a subject in the image, then the change in the image size leads to a change of its annotation result, the bounding box size, by an exactly the same scaling factor.

At 1008, the test question is sent to an annotator device of a second contributor. In some embodiments, a manipulated consistency test question can be sent to the same contributor as the one from which its corresponding test answer may have been derived. Put another way, the “first” contributor can be the same contributor as the “second” contributor in process 1000. In some embodiments, a manipulated consistency test question can be sent to a different contributor from the one from which its corresponding test answer may have been derived. Put another way, the “first” contributor and the “second” contributor are different contributors in process 1000.

At 1010, a submitted answer to the test question is received from the second contributor user via the annotator device.

At 1012, whether the submitted answer is correct is determined. In the event that the submitted answer is correct, control is transferred to 1018. Otherwise, in the event that the submitted answer is not correct, control is transferred to 1014. The second contributor user's submitted answer to the test question is compared to the known/correct test answer to determine whether the match/similarity is greater than a threshold. In the manipulated consistency test, the second/target contributor is tested on whether he or she can consistently perform the same annotations as another contributor on a manipulated version of the same presented query/test question. One reason to manipulate a query in the generation of a test question is to prevent the target contributor from relying on rote memorization to correctly answer the test question.

At 1014, a first annotation job trust level associated with the first contributor is decreased. In the event that the second contributor has not consistently annotated the same query as the first contributor, then the first contributor is also penalized for the lack of consistency with a decrease to their trust level with respect to the current annotation job. The lack of consistency across two contributors' performance on the same query could indicate a lack of reliability on the part of each contributor.

At 1016, a second annotation job trust level associated with the second contributor is decreased. In the event that the second contributor has not consistently annotated the same query as the first contributor, then the second contributor is penalized for the lack of consistency with a decrease to their trust level with respect to the current annotation job.

At 1018, the first annotation job trust level associated with the first contributor is increased. In the event that the second contributor consistently annotated the same query as the first contributor, then the first contributor is rewarded for the validation/consistency that is provided by the second contributor's submitted answer to the test answer with an increase to the first contributor's trust level with respect to the current annotation job.

At 1020, the second annotation job trust level associated with the second contributor is increased. In the event that the second contributor consistently annotated the same query as the first contributor, then the second contributor is rewarded for the consistency of the second contributor's submitted answer with the test answer with an increase to the second contributor's trust level with respect to the current annotation job.

FIG. 11 is a diagram showing an example of the generation and the assignment of a manipulated consistency type of test question. In the example of FIG. 11, the selected annotation type associated with the annotation job is to label an animal that appears within an image. As shown in FIG. 11, Query 1 comprising an image of a duck is sent to the annotator device of Contributor 1. Because Query 1 is a unit of input data associated with the annotation job that is to be annotated, Query 1 does not come with a correct answer. After receiving Query 1, Contributor 1 submits a submitted annotation to the image, which is the label of “Duck.” Query 1 is then selected to become the basis of a manipulated consistency test and so a test question, Test Question 1, that is a manipulated version of Query 1 is generated. In this example, Test Question 1 is generated by flipping Query 1 horizontally. Because this manipulation does not change the annotation for the image, the known/correct test answer to Test Question 1 is then generated to be the equivalent to Contributor 1's submitted annotation to the image, “Duck.” Test Question 1 is then assigned to a contributor, Contributor 2, to determine whether Contributor 2 can submit a consistent annotation result (submitted answer) relative to Contributor 1 to this image. Contributor 2 could be a different contributor as Contributor 1, or Contributor 2 could be the same contributor as Contributor 1. If Contributor 2 does submit a consistent annotation result (“Duck”), then Contributor 2 is deemed consistent and is rewarded with an increase in his or her trust level with respect to the annotation job. In some embodiments, if Contributor 2 does submit a consistent annotation result (“Duck”), then Contributor 1 is also rewarded with an increase in his or her trust level with respect to the annotation job.

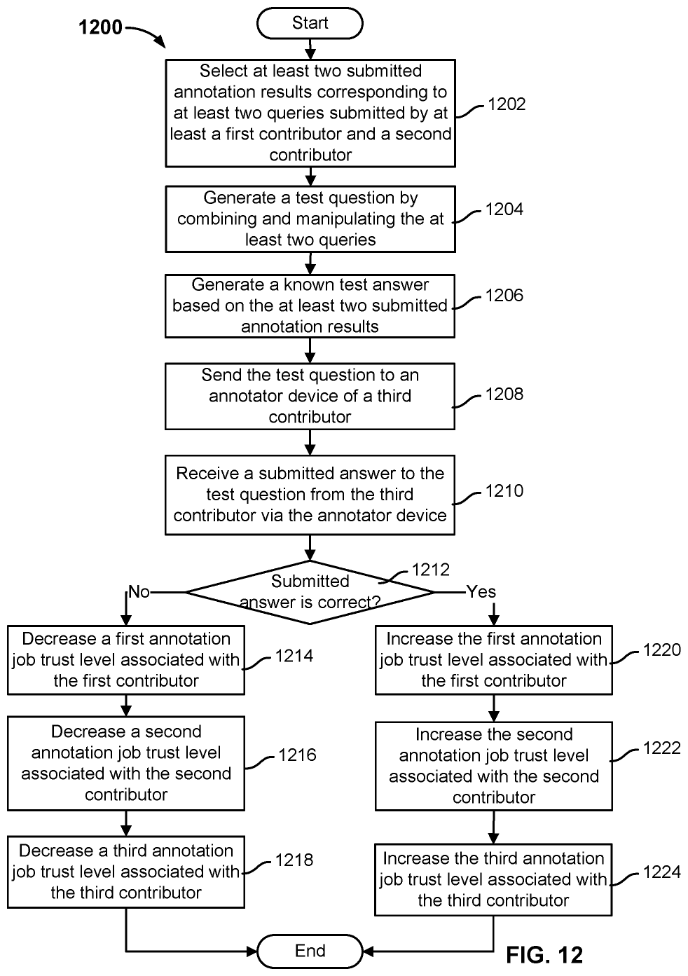

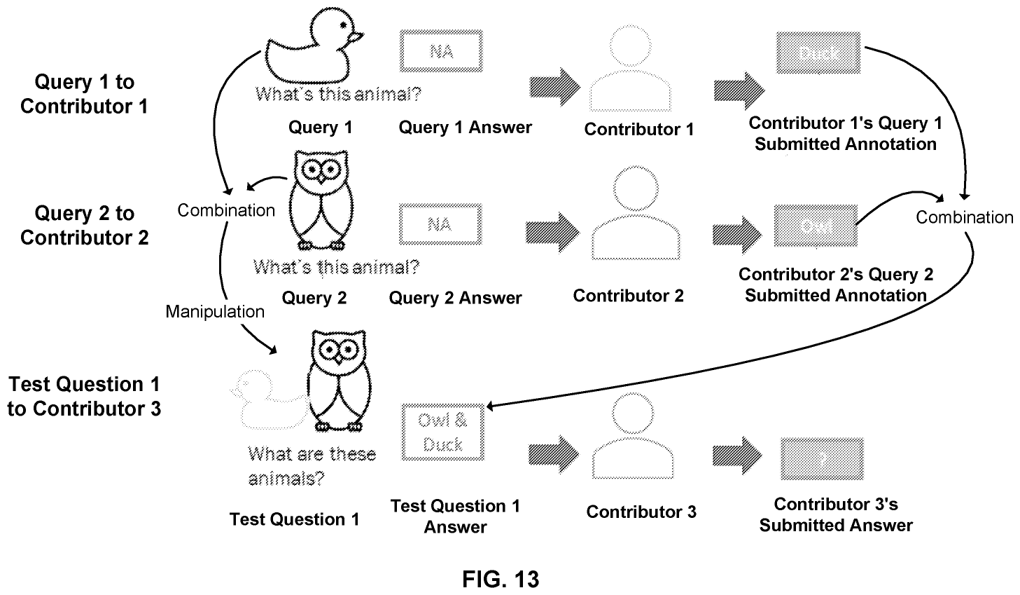

FIGS. 12 and 13 describe examples of dynamically generating a fourth example type of test question that is referred to as the “manipulated combination consistency test.”

FIG. 12 is a flow diagram showing an example of a process for dynamically generating the manipulated combination consistency type of test question. In some embodiments, process 1200 can be implemented by an annotation platform server such as annotation platform server 116 of FIG. 1. In some embodiments, step 510 of process 500 of FIG. 5 may be implemented, at least in part, using process 1000.

At 1202, at least two submitted annotation results submitted by at least a first contributor and a second contributor corresponding to at least two queries are selected. In some embodiments, two or more queries in an annotation job for which respective contributor users had submitted an annotation result are selected based on selection criteria. The two or more submitted annotation results could have been submitted by the same contributor or two or more different contributors.

At 1204, a test question is generated based on combining and manipulating the at least two queries. In the manipulated combination consistency test, a modified/manipulated version of a combination of two queries is used as a test question. In some embodiments, the queries are first combined and then the combination is manipulated. In some embodiments, at least one of the queries is first individually manipulated before being combined with the other queries. In some embodiments, one or more of the queries could be individually manipulated and then combined with the other(s) to generate the test question. How the selected queries are combined and manipulated depends on the type of data and/or selected annotation type that is associated with the queries/input data of the annotation job. In a first example, if each query were text and the selected annotation type is to label parts of speech, then the two or more queries could be appended one after another and then, optionally, further manipulated to add more noise (words). In a second example, if each query were an image and the selected annotation type is to label subject(s) in an image, then the images could be placed adjacent or overlapping relative to each other and optionally, further manipulated to change in size, receive added noise, and receive an at least partially occluding element.

At 1206, a known test answer is dynamically generated based on the at least two submitted annotation results. Depending on the type of manipulation and the selected annotation type of the annotation job, the known/correct test answer corresponding to the test question could be equivalent to the combination of the first contributor's original submitted annotation result and the second first contributor's original submitted annotation result to the queries selected at step 1202 or a meta annotator program based on the manipulated combination of the queries/test question. For example, if the combination and then manipulation of the queries in the generation of the test question should not change the annotations of the queries, then a combination (e.g., by a Boolean operator of “AND”) of the first and second contributors' submitted annotation results can be used as the known/correct test answer. For instance, if the queries were images and the selected annotation type is to label a subject in the image, then generating a combined image of the two originals placed adjacently to each other and either changing the size of the combined image or the flipping of the combined image should not change its annotation results.

While not shown at step 1206, in another example, if the combination and manipulation of the queries in the generation of the test question could likely change the annotations of the manipulated combination, then a meta annotator program that is designed to perform the selected annotation type associated with the annotation is used to output a prediction/classification, which will be used as the known/correct test answer. For instance, if the queries were images and the selected annotation type is to draw bounding boxes around a desired type of subjects in the image, then a manipulated combination that stiches a first image to the second should lead to a horizontal shift of a portion of the original annotations: the positions of the bounding boxes in the first image have changed in the combined mosaic image.

At 1208, the test question is sent to an annotator device of a third contributor. In some embodiments, a manipulated combination consistency test question can be sent to one of the same contributors as the ones from which its corresponding test answer may have been derived. Put another way, the “third” contributor could be the same contributor as one or both of the “first” contributor and the “second” contributor in process 1200. In some embodiments, a manipulated combination consistency test question can be sent to a different contributor than one from which its corresponding test answer may have been derived. Put another way, the “third” contributor could be a contributor different from the “first” contributor and the “second” contributor in process 1200.

At 1210, a submitted answer to the test question is received from the third contributor user via the annotator device.

At 1212, whether the submitted answer is correct is determined. In the event that the submitted answer is correct, control is transferred to 1220. Otherwise, in the event that the submitted answer is not correct, control is transferred to 1214. The third contributor user's submitted answer to the test question is compared to the known/correct test answer to determine whether the match/similarity is greater than a threshold. In the manipulated combination consistency test, the third/target contributor is tested on whether he or she can consistently perform the same annotations as at least two contributors on a manipulated version of a combination of the queries that the at least two contributors had worked on.

At 1214, a first annotation job trust level associated with the first contributor is decreased. In the event that the third contributor has not consistently annotated the same query as the first contributor and the second contributor, then the first contributor is also penalized for the lack of consistency with a decrease to their trust level with respect to the current annotation job. The lack of consistency across three contributors' performance on the same query could indicate a lack of reliability on the part of each contributor.

At 1216, a second annotation job trust level associated with the second contributor is decreased. In the event that the third contributor has not consistently annotated the same query as the first contributor and the second contributor, then the second contributor is also penalized for the lack of consistency with a decrease to their trust level with respect to the current annotation job.

At 1218, a third annotation job trust level associated with the third contributor is decreased. In the event that the third contributor has not consistently annotated the same query as the first contributor and the second contributor, then the third contributor is also penalized for the lack of consistency with a decrease to their trust level with respect to the current annotation job.

At 1220, the first annotation job trust level associated with the first contributor is increased. In the event that the third contributor consistently annotated the same query as the first contributor and the second contributor, then the first contributor is rewarded for the validation/consistency with an increase to the first contributor's trust level with respect to the current annotation job.

At 1222, the second annotation job trust level associated with the second contributor is increased. In the event that the third contributor consistently annotated the same query as the first contributor and the second contributor, then the second contributor is also rewarded for the validation/consistency with an increase to the second contributor's trust level with respect to the current annotation job.

At 1224, the third annotation job trust level associated with the third contributor is increased. In the event that the third contributor consistently annotated the same query as the first contributor and the second contributor, then the third contributor is rewarded for the consistency with an increase to the third contributor's trust level with respect to the current annotation job.

FIG. 13 is a diagram showing an example of the generation and the assignment of a manipulated consistency type of test question. In the example of FIG. 13, the selected annotation type associated with the annotation job is to label an animal that appears within an image. As shown in FIG. 13, Query 1 comprising an image of a duck is sent to the annotator device of Contributor 1. Because Query 1 is a unit of input data associated with the annotation job that is to be annotated, Query 1 does not come with a correct answer. After receiving Query 1, Contributor 1 submits a submitted annotation to the image, which is the label of “Duck.” Query 2 comprising an image of an owl is sent to the annotator device of Contributor 2. Because Query 2 is a unit of input data associated with the annotation job that is to be annotated, Query 2 does not come with a correct answer. After receiving Query 2, Contributor 2 submits a submitted annotation to the image, which is the label of “Owl.” Both Query 1 and Query 2 are then selected to become the basis of a manipulated combination consistency test and so a test question, Test Question 1, that is a combination of a manipulated Query 1 and Query 2 is generated. In this example, Test Question 1 is generated by flipping Query 1 horizontally and then combining that with the unmodified version of Query 2. Because this manipulation does not change the annotation for the combined image, the known/correct test answer to Test Question 1 is then generated to be the combination (e.g., based on the Boolean operator “AND”) of Contributor 1's submitted annotation to Query 1, “Duck”, and Contributor 2's submitted annotation to Query 2, “Owl.” Test Question 1 is then assigned to a contributor, Contributor 3, to determine whether Contributor 3 can submit a subsequently consistent annotation result (submitted answer) relative to Contributor 1 and Contributor 2 for the two images that were combined. Contributor 3 could be a different contributor relative to Contributor 1 and Contributor 2, or Contributor 3 could be the same contributor as one of Contributor 1 or Contributor 2. If Contributor 3 does submit a consistent annotation result (“Owl and duck”), then Contributor 3 is deemed consistent and is rewarded with an increase in his or her trust level with respect to the annotation job. In some embodiments, if Contributor 3 does submit a consistent annotation result (“Duck and owl”), then Contributor 1 and Contributor 2 are also rewarded with an increase in their trust levels with respect to the annotation job.

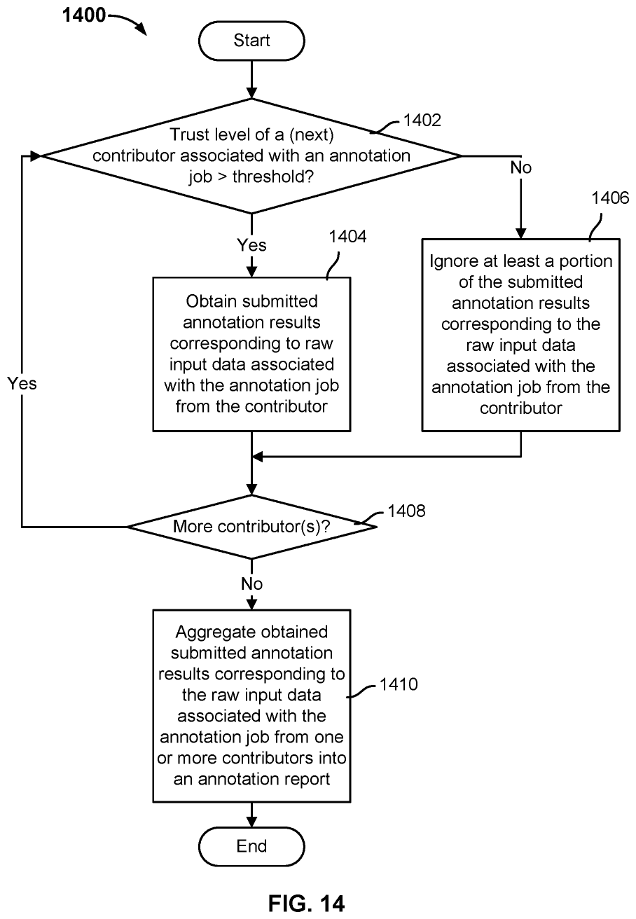

FIG. 14 is a flow diagram showing an example of a process for aggregating contributor user submitted annotation results for an annotation job. In some embodiments, process 1400 is implemented at system 100 of FIG. 1. Specifically, in some embodiments, process 1400 is implemented at annotation platform server 116 of system 100 of FIG. 1.

Process 1400 describes an example process by which the submitted annotation results from one or more contributor users with respect to an annotation job may be aggregated into an annotation report for the annotation job.

At 1402, whether a trust level of a (next) contributor user associated with an annotation job is greater than a predetermined trust level threshold is determined. In the event that the annotation job trust level is greater than the threshold, control is transferred to 1404. Otherwise, in the event that the annotation job trust level is not greater than the threshold, control is transferred to 1406. As mentioned above, depending on a contributor user's annotation job trust level, that contributor user's submitted annotation results may be partially or completely excluded from being aggregated into an annotation report corresponding to the annotation job.

At 1404, submitted annotation results corresponding to raw input data associated with the annotation job from the contributor user are obtained.

At 1406, at least a portion of submitted annotation results corresponding to raw input data associated with the annotation job from the contributor user is ignored. In some embodiments, if the contributor user's annotation job trust level is below the threshold, then all of the contributor's submitted annotation results for one or more queries (units of raw input data) from the annotation job are excluded from the annotation report. In some other embodiments, if the contributor user's annotation job trust level is below the threshold, then only the portion of the contributor's submitted annotation results for one or more queries in the job batch in which the contributor user's trust level fell below the threshold is excluded from the annotation report. In some embodiments, after a contributor user's trust level fell below the threshold after providing annotation results for a given job batch, the contributor user was not provided a subsequent job batch from that same annotation job.

At 1408, whether there is at least one more contributor user associated with the annotation job is determined. In the event that there is at least one more contributor user associated with the annotation job, control is returned to 1402. Otherwise, if there are no more contributor users associated with the annotation job, control is transferred to 1410.

At 1410, obtained submitted annotation results corresponding to the raw input data associated with the annotation job from one or more contributor users are aggregated into an annotation report. For example, aggregating submitted annotation results corresponding to the raw input data associated with the annotation job from one or more contributor users comprises grouping together submitted annotation results for the same query and then determining an aggregate annotation (e.g., the most frequently occurring annotation result) for that query based on the grouped submitted annotation results. In some embodiments, the annotation report comprises a corresponding aggregate annotation result for each query associated with the annotation job. In some embodiments, the annotation report is then output to the annotation job creator user who had initially submitted the annotation job.

Embodiments of dynamically generated test questions and test answers for automatic quality control of submitted annotations are described herein. By using contributor submitted annotation results to dynamically generate test questions and answers while an annotation job is being worked on by contributor users, the pool of test questions can easily expand and without requiring any manual generation of test questions prior to starting the annotation job. The dynamically generated test questions can then be used to evaluate the quality of work of contributor users who have submitted annotation results for the raw input data associated with the annotation job. By monitoring the quality of test answers submitted by contributor users to test questions associated with the annotation job, the annotation platform server can programmatically determine whether a contributor user should continue to work on the annotation job or be removed from the annotation job.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory; and
a processor coupled to the memory and configured to:
distribute a first subset of queries from input data associated with an annotation job to a plurality of annotator devices via an annotation platform;
receive a set of annotation results corresponding to the first subset of queries from the plurality of annotator devices;
dynamically generate a set of test questions and corresponding test answers based at least in part on the first subset of queries and the set of annotations results;
distribute a second subset of queries from the input data and the set of test questions to the plurality of annotator devices via the annotation platform; and
perform an action corresponding to a contributor with respect to the annotation job based at least in part on a submitted answer, received from a corresponding annotator device, corresponding to at least one test question of the set of test questions.

2. The system of claim 1, wherein to generate the set of test questions and the corresponding test answers based at least in part on the first subset of queries and the set of annotations results comprises to:
generate a first test question based on a query from the first subset of queries; and
generate a known test answer to the first test question based on a first annotation result submitted by the contributor to the query.

3. The system of claim 2, wherein the first test question is distributed to the annotator device corresponding to the contributor, and wherein the processor is further configured to:
compare the submitted answer from the contributor to the known test answer to determine whether the submitted answer matches the known test answer; and
in response to a determination that the submitted answer matches the known test answer, increase a trust level associated with the contributor with respect to the annotation job.

4. The system of claim 1, wherein the contributor comprises a first contributor, wherein to generate the set of test questions and corresponding test answers based at least in part on the first subset of queries and the set of annotations results comprises to:
generate a first test question based on a query from the first subset of queries; and
generate a known test answer to the first test question based on an annotation result submitted by a second contributor to the query, wherein the second contributor is different from the first contributor.

5. The system of claim 4, wherein the first test question is distributed to the annotator device corresponding to the first contributor, and wherein the processor is further configured to:
compare the submitted answer from the first contributor to the known test answer to determine whether the submitted answer matches the known test answer; and
in response to a determination that the submitted answer matches the known test answer:
increase a first trust level associated with the first contributor with respect to the annotation job; and
increase a second trust level associated with the second contributor with respect to the annotation job.

6. The system of claim 1, wherein the contributor comprises a first contributor, wherein to generate the set of test questions and corresponding test answers based at least in part on the first subset of queries and the set of annotations results comprises to:
generate a first test question based on manipulating a query from the first subset of queries; and
generate a known test answer to the first test question based on an annotation result submitted by a second contributor to the query.

7. The system of claim 6, wherein the first test question is distributed to the annotator device corresponding to the first contributor, and wherein the processor is further configured to:
compare the submitted answer from the first contributor to the known test answer to determine whether the submitted answer matches the known test answer; and
in response to a determination that the submitted answer matches the known test answer:
increase a first trust level associated with the first contributor with respect to the annotation job; and
increase a second trust level associated with the second contributor with respect to the annotation job.

8. The system of claim 1, wherein the contributor comprises a first contributor, wherein to generate the set of test questions and corresponding test answers based at least in part on the first subset of queries and the set of annotations results comprises to:
generate a first test question based on combining and manipulating a first query and a second query from the first subset of queries; and
generate a known test answer to the first test question based on combining a first annotation result submitted by a second contributor to the first query and a second annotation result submitted by a third contributor to the second query.

9. The system of claim 8, wherein the first test question is distributed to the annotator device corresponding to the first contributor, and wherein the processor is further configured to:
compare the submitted answer from the first contributor to the known test answer to determine whether the submitted answer matches the known test answer; and
in response to a determination that the submitted answer matches the known test answer:
increase a first trust level associated with the first contributor with respect to the annotation job;
increase a second trust level associated with the second contributor with respect to the annotation job; and
increase a third second trust level associated with the third contributor with respect to the annotation job.

10. The system of claim 1, wherein a first test question is selected to be distributed to the corresponding annotator device of the contributor based at least in part on a speed of annotation submission from the contributor.

11. The system of claim 1, wherein a first test question is selected to be distributed to the corresponding annotator device of the contributor based at least in part on a performance by the contributor on the annotation job as compared to respective performances by other contributors on the annotation job.

12. The system of claim 1, wherein to perform the action corresponding to the contributor comprises to:
determine an updated trust level associated with the contributor with respect to the annotation job based at least in part on a comparison between the submitted answer and a known test answer corresponding to the at least one test question;
determine that the updated trust level associated with the contributor is less than a threshold trust level; and
stop distributing a subsequent job batch comprising queries from the input data associated with the annotation job to the corresponding annotator device of the contributor.

13. The system of claim 1, wherein to perform the action corresponding to the contributor comprises to:
determine an updated trust level associated with the contributor with respect to the annotation job based at least in part on a comparison between the submitted answer and a known test answer corresponding to the at least one test question;
determine that the updated trust level associated with the contributor is less than a threshold trust level; and
exclude annotation results received from the corresponding annotator device of the contributor from being aggregated into an annotation report corresponding to the annotation job.

14. A method, comprising:
distributing a first subset of queries from input data associated with an annotation job to a plurality of annotator devices via an annotation platform;
receiving a set of annotation results corresponding to the first subset of queries from the plurality of annotator devices;
dynamically generating a set of test questions and corresponding test answers based at least in part on the first subset of queries and the set of annotations results;
distributing a second subset of queries from the input data and the set of test questions to the plurality of annotator devices via the annotation platform; and
performing an action corresponding to a contributor with respect to the annotation job based at least in part on a submitted answer, received from a corresponding annotator device, corresponding to at least one test question of the set of test questions.

15. The method of claim 14, wherein generating the set of test questions and the corresponding test answers based at least in part on the first subset of queries and the set of annotations results comprises:
generating a first test question based on a query from the first subset of queries; and
generating a known test answer to the first test question based on a first annotation result submitted by the contributor to the query.

16. The method of claim 14, wherein the contributor comprises a first contributor, wherein generating the set of test questions and corresponding test answers based at least in part on the first subset of queries and the set of annotations results comprises:
generating a first test question based on a query from the first subset of queries; and
generating a known test answer to the first test question based on an annotation result submitted by a second contributor to the query, wherein the second contributor is different from the first contributor.

17. The method of claim 14, wherein the contributor comprises a first contributor, wherein generating the set of test questions and corresponding test answers based at least in part on the first subset of queries and the set of annotations results comprises:
generating a first test question based on manipulating a query from the first subset of queries; and
generating a known test answer to the first test question based on an annotation result submitted by a second contributor to the query.

18. The method of claim 14, wherein the contributor comprises a first contributor, wherein generating the set of test questions and corresponding test answers based at least in part on the first subset of queries and the set of annotations results comprises:
generating a first test question based on combining and manipulating a first query and a second query from the first subset of queries; and
generating a known test answer to the first test question based on combining a first annotation result submitted by a second contributor to the first query and a second annotation result submitted by a third contributor to the second query.

19. The method of claim 14, wherein a first test question is selected to be distributed to the corresponding annotator device of the contributor based at least in part on a speed of annotation submission from the contributor.

20. A computer program product, the computer program product being embodied in a non-transitory computer readable storage medium and comprising computer instructions for:
distributing a first subset of queries from input data associated with an annotation job to a plurality of annotator devices via an annotation platform;
receiving a set of annotation results corresponding to the first subset of queries from the plurality of annotator devices;
dynamically generating a set of test questions and corresponding test answers based at least in part on the first subset of queries and the set of annotations results;
distributing a second subset of queries from the input data and the set of test questions to the plurality of annotator devices via the annotation platform; and
performing an action corresponding to a contributor with respect to the annotation job based at least in part on a submitted answer, received from a corresponding annotator device, corresponding to at least one test question of the set of test questions.
